(19) United States
(12) Patent Application Publication
(10) Pub. No.: US 2026/0371150 A1
(43) Pub. Date: Nov. 19, 2026

(54) TRANSFER OF ARTIFICIAL INTELLIGENCE NETWORK MANAGEMENT MODELS IN WIRELESS COMMUNICATION SYSTEMS

(71) Applicant: ZTE CORPORATION, Shenzhen, Guangdong (CN)

(72) Inventors: Fei DONG, Shenzhen (CN); He HUANG, Shenzhen (CN); Jing LIU, Shenzhen (CN); Guozeng ZHENG, Shenzhen (CN)

(21) Appl. No.: 19/154,395

(22) PCT Filed: Feb. 10, 2023
(86) PCT No.: PCT/CN2023/075527

§ 371 Date: Aug. 7, 2025

(51) Int. Cl. H04W 28/02; H04L 41/16; H04W 64/00; H04W 72/543

(52) U.S. Cl. CPC H04W 28/0252; H04L 41/16; H04W 28/0205; H04W 64/006; H04W 72/543

(57) ABSTRACT

Provided are methods and network devices for assisting in intelligent management of wireless communication systems and is particularly directed to procedures for transmission and reception of Artificial Intelligence (AI) network management models between the various network devices. Depending on the functions of AI models, the end points of the AI model transfer may be a wireless terminal device and a wireless base station communicated via an air interface. Alternatively end points of the AI model transfer may be the wireless terminal device and a core network device of the wireless communication network via the wireless base station. Within the air interface between the wireless terminal and the wireless base station, the AI models may be transferred using Signaling Radio Bearer (SRB) or Data Radio Bearer (DRB) resources. These resources may be based on shared SRB or DRB resources with their configuration adapted to accommodate AI model transfer.

### CROSS-REFERENCE TO RELATED APPLICATION

This disclosure is a national stage filing under 35 U.S.C. § 371 of international application number PCT/CN 2023/075527, filed on Feb. 10, 2023, the entire disclosure of which is incorporated herein by reference.

### TECHNICAL FIELD

This disclosure is generally directed to methods and network devices for assisting in intelligent management of wireless communication systems and is particularly directed to procedures for transmission and reception of Artificial Intelligence (AI) network management models between the various network devices.

### BACKGROUND

In a wireless communication system, determination of adaptive network configuration particularly with respect an over-the-air communication interface and radio resources may require lengthy measurement processes and/or significant amounts of computation power. Such types of configurations may include but are not limited to beam management, channel state information (CSI) feedback compression and decompression schemes, and wireless terminal positioning management. Correlation between various network conditions and these adaptive configurations may be learned via artificial intelligence (AI) techniques and models. Such AI models, as trained and managed on one network device, may need to be communicated to another network devices via the over-the-air interface and potentially other network interfaces. While these AI models are used for control purposes, they are very different from typical control information in that they may contain a larger amount of data (e.g., a large number of hyper parameters and actual model parameters) requiring a significant amount of over-the-air communication resources.

### SUMMARY

This disclosure is generally directed to methods and network devices for assisting in intelligent management of wireless communication systems and is particularly directed to procedures for transmission and reception of Artificial Intelligence (AI) network management models between the various network devices. Depending on the functions of AI models, the end points of the AI model transfer may be a wireless terminal device and a wireless base station communicated via an air interface. Alternatively end points of the AI model transfer may be the wireless terminal device and a core network device of the wireless communication network via the wireless base station. Within the air interface between the wireless terminal and the wireless base station, the AI models may be transferred using Signaling Radio Bearer (SRB) or Data Radio Bearer (DRB) resources. These resources may be based on shared SRB or DRB resources with their configuration adapted to accommodate AI model transfer, alternatively, these resources may be configured as dedicated radio resources for the transfer of the AI models. The transfer for the AI models between a core network node and an intermediate wireless base station may be effectuated either in a Control Plane (CP) or User Plane (UP) of the wireless network. Various messaging schemes for resource allocations for the AI model transfer may be correspondingly implemented.

In one implementation, a method by a first device to communicate with a second device in a wireless communication system is disclosed. The first device and the second device are respectively one and another of a wireless terminal and a core network (CN) node, the wireless terminal and the core network node being communicatively connected via a wireless base station. The method may include performing a request-response procedure with the second device for initiating a transfer of an Artificial Intelligence (AI) network management model therebetween; identifying a radio bearer resource in an air interface between the wireless terminal and the wireless base station for the transfer of the AI network management model; and performing the transfer of the AI network management model over the radio bearer resource and a control plane of the wireless communication system.

In the implementation above, the CN node comprises a Location Management Function (LMF) node. The AI network management model may include a location management AI model. The transfer of the AI network management model may be performed according to an LTE Positioning Protocol (LPP). The radio bearer resource may include a Signaling Radio Bearer (SRB) resource and the transfer of the AI network management model is performed over the SRB resource and at least one control interface between the wireless base station and the LMF node.

In some implementations, the radio bearer resource may include a Data Radio Bearer (DRB) resource and the transfer of the AI network management model is performed over the DRB resource between the first device and the wireless base station and additionally over at least one control interface in the control plane between the wireless base station and second device.

In some implementations, the wireless terminal and the LMF node may be communicatively connected via the wireless base station and an intermediate Access Management Function (AMF) node. The request-response procedure may include transmitting an LPP request message comprising at least one of a first identifier for identifying an AI based function to which the AI network management model belong; an attribute of the AI network management model a second identifier for indicating a service associated with the AI network management model; a third identifier for identifying the wireless terminal with respect to the LMF; a fourth identifier for indicating a cell to which the wireless terminal is connected; or a location information.

In some implementations, the request-response procedure may trigger a data tunnel request from the LMF to the AMF for the transfer of the AI network management model, and the data tunnel request may include at least one of at least one attribute of the AI network management model; or a QoS requirement associated with the transfer of the AI network management model. The data tunnel request triggers the AMF to transmit an AI model transfer resource request to the wireless base station requesting data radio bearer resources for one or more QoS flows or one or more PDU sessions, and the AI model transfer resource request may include at least one of PDU Session identifiers for identifying the one or more PDU sessions whose QoS flows need to be modified, or which need the wireless base station to establish air-interface resources; QoS flow identifiers for identifying the one or more QoS flows which need to be added or modified for the model transfer or which need to be included the identified PDU sessions; an endpoint IP address of the model transfer; the at least one attribute of the AI network management model; or the QoS requirement associated with the transfer of the AI network management model.

In some implementations, the AI model transfer resource request may trigger the wireless base station to initiate an RRC reconfiguration for mapping the one or more QoS flows or one or more PDU sessions to the radio bearer resource for the transfer of the AI network management model via at least one of a list of AI model transfer specific QoS flows present in an SDAP configuration; a configuration indicating a presence of an SDAP PDU header; a first flag that enables mapping a present QFI list in the SDAP configuration to the transfer of the AI network management model; a second flag in a DRB configuration indicating that a corresponding DRB is for AI network management model transfer; a third flag in an SDAP configuration indicating that a corresponding DRB is for AI network management model transfer; a fourth flag in a PDCP configuration indicating that a corresponding DRB is for AI network management model transfer; or a fifth flag in an RLC configuration indicating that a corresponding DRB is for AI network management model transfer.

In some implementations, a response to the AI model transfer resource request from the wireless base station to the AMF may include at least one of a first identifier for indicating a mobile terminal specific Access Management Function (AMF) ID with respect to a NG Application Protocol (NGAP) interface; a second identifier to indicate a mobile terminal specific Radio Access network (RAN) ID with respect to the NGAP interface; the QoS flow identifiers for identifying the one or more QoS flows which are confirmed as successfully modified or as successfully added; the PDU session identifiers for identifying the one or more PDU sessions confirmed as successfully set up or modified; a third identifier for indicating a failed PDU session allocation or a failed QoS flow allocation for the transfer of the AI network management model; or at least one reason for the failed PDU session allocation or the failed QoS flow allocation.

In some implementations, the CN node may include an Access Management Function (AMF) node. The request-response procedure comprises an NAS request for AI model transfer that is transparent to the wireless base station, and the NAS request may include at least one of a first identifier for identifying an AI based function to which the AI network management model belong; an attribute of the AI network management model; a second identifier for identifying the wireless terminal; or a transaction identifier for identifying the transfer of the AI network management model. The request-response procedure may include the wireless base station establishing an SRB resource dedicated to a purpose of AI network management model transfer.

In another implementation, a method by a first device to communicate with a second device in a wireless communication system is disclosed. The first device and the second device are respectively one and another of a wireless terminal and a network node, the wireless terminal and the network node being communicatively connected via a wireless base station, the network node being either a virtual Data Network Node (vDNN) or an Operation/Administration/Maintenance (OAM) node of the wireless communication system. The method may include performing a request-response procedure with the second device for initiating a transfer of an AI network management model between the first device and the second device; identifying one or more PDU sessions between the first device and the second device; and performing the transfer of the AI network management model between the first device and the second device using the one or more PDU sessions.

In some implementations, the request-response procedure may include transmitting or receiving a first NAS message contained in a first RRC message as a request, the first NAS message comprising at least one of a first identifier for identifying an AI based function to which the AI network management model belong; an attribute of the AI network management model; or an endpoint IP address of the wireless terminal. The request-response procedure may further include transmitting or receiving a second NAS message contained in a second RRC message, the second NAS message being configured to trigger a PDU session establishment procedure for the transfer of the AI network management model. The second NAS message may include at least one of a confirmation for receiving the request; a rejection of the request; or at least one reason for the rejection.

In some other implementations, an electronic device comprising a processor and a memory is disclosed. The processor may be configured to read computer code from the memory to implement any one of the methods above.

In yet some other implementations, a computer program product comprising a non-transitory computer-readable program medium with computer code stored thereupon is disclosed. The computer code, when executed by a processor, may cause the processor to implement any one of the methods above.

The above embodiments and other aspects and alternatives of their implementations are described in greater detail in the drawings, the descriptions, and the claims below.

### BRIEF DESCRIPTION OF THE DRAWINGS

FIG. 1 illustrates an example wireless communication network including a wireless access network, a core network, and data networks.

FIG. 2 illustrates an example wireless access network including a plurality of mobile stations/terminals or UEs and a wireless access network node in communication with one another via an over-the-air radio communication interface.

FIG. 3 shows an example core network.

FIG. 4 shows an example communication protocol stack in a wireless access network node or wireless terminal device including various network layers.

FIG. 5 shows an example flow chart for transferring AI models between a mobile station/terminal and a base station without core network involvement.

FIG. 6 shows an example flow chart for transferring AI models between a mobile station/terminal and a base station with the core network involvement.

FIG. 7 shows another example flow chart for transferring AI models between a mobile station/terminal and a base station with the core network involvement.

FIG. 8 shows an example flow chart for transferring AI models between a mobile station/terminal and a core network based on LTE Positioning Protocol (LPP).

FIG. 9 shows another example flow chart for transferring AI models between a mobile station/terminal and a core network based on LPP.

FIG. 10 shows another example flow chart for transferring AI models between a mobile station/terminal and a core network based on LPP.

FIG. 11 shows an example flow chart for transferring AI models between a mobile station/terminal and a core network in the control plane.

FIG. 12 shows another example flow chart for transferring AI models between a mobile station/terminal and a core network in the control plane.

FIG. 13 shows an example flow chart for transferring AI models between a mobile station/terminal and a core network in the user plane.

FIG. 14 shows another example flow chart for transferring AI models between a mobile station/terminal and a core network in the user plane.

### DETAILED DESCRIPTION

The technology and examples of implementations and/or embodiments described in this disclosure can be used to facilitate transmitting and receiving Artificial Intelligence (AI) network management models between various wireless network devices or nodes via at least one over-the-air interface. The term “over-the-air interface” is used interchangeably with “air interface” or “radio interface” in this disclosure. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is generally directed to methods and network devices for assisting in intelligent management of wireless communication systems and is particularly directed to procedures for transmission and reception of Artificial Intelligence (AI) network management models between the various network devices. These AI network management models may be used to achieve various AI network configuration functions. Such AI network configuration functions may be provided as services for AI-assisted network configuration (AI configuration services, or AICS). Such AICS may be requested and configured via various messaging and signaling mechanisms. The AI model life cycle management including training, activation, inference, deactivation, switching, performance evaluation, and the like may be configured, triggered, and otherwise provisioned via control and data messages and signaling communicated between the various network elements in the wireless communication system. In one particular aspect, trained AI models residing and managed at a particular network node may need to be transferred to another network node. Because these AI models usually contain large mount of data, allocation of the network communication resources (including radio resources in the air interface and other communication resources) and configuration for their transfer may be treated in different manners in comparison to other control information being communicated in the network.

### Wireless Network Overview

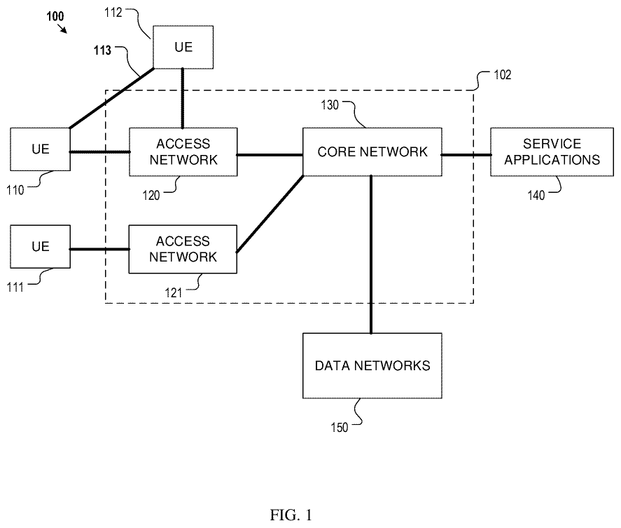

An example wireless communication network, shown as 100 in FIG. 1, may include wireless terminal devices or user equipment (UE) 110, 111, and 112, a carrier network 102, various service applications 140, and other data networks 150. The wireless terminal devices or UEs, may be alternatively referred to as wireless terminals. The carrier network 102, for example, may include access network nodes 120 and 121, and a core network 130. The carrier network 110 may be configured to transmit voice, data, and other information (collectively referred to as data traffic) among UEs 110, 111, and 112, between the UEs and the service applications 140, or between the UEs and the other data networks 150. The access network nodes 120 and 121 may be configured as various wireless access network nodes (WANNs, alternatively referred to as wireless base stations) to interact with the UEs on one side of a communication session and the core network 130 on the other. The term “access network” may be used more broadly to refer a combination of the wireless terminal devices 110, 111, and 112 and the access network nodes 120 and 121. A wireless access network may be alternatively referred to as Radio Access Network (RAN). The core network 130 may include various network nodes configured to control communication sessions and perform network access management and traffic routing. The service applications 140 may be hosted by various application servers deployed outside of but connected to the core network 130. Likewise, the other data networks 150 may also be connected to the core network 130.

In the example wireless communication network of 100 of FIG. 1, the UEs may communicate with one another via the wireless access network. For example, UE 110 and 112 may be connected to and communicate via the same access network node 120. The UEs may communicate with one another via both the access networks and the core network. For example, UE 110 may be connected to the access network node 120 whereas UE 111 may be connected to the access network node 121, and as such, the UE 110 and UE 111 may communicate to one another via the access network nodes 120 and 121, and the core network 130. The UEs may further communicate with the service applications 140 and the data networks 150 via the core network 130. Further, the UEs may communicate to one another directly via side link communications, as shown by 113.

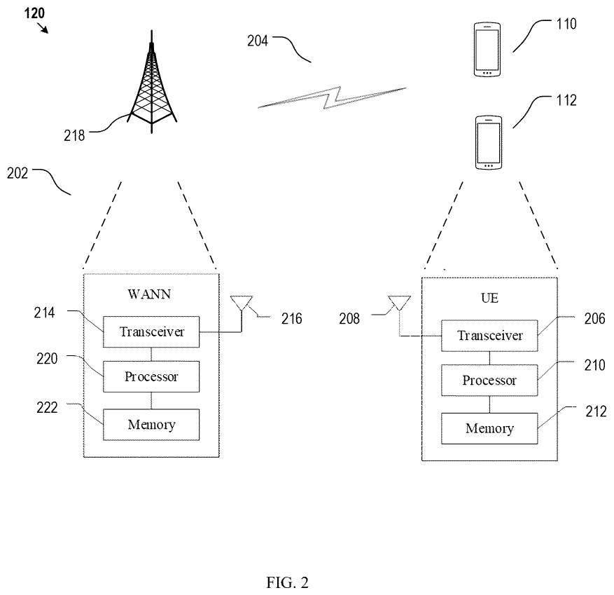

FIG. 2 further shows an example system diagram of the wireless access network 120 including a WANN 202 serving UEs 110 and 112 via the over-the-air interface 204. The wireless transmission resources for the over-the-air interface 204 include a combination of frequency, time, and/or spatial resource. Each of the UEs 110 and 112 may be a mobile or fixed terminal device installed with mobile access units such as SIM/USIM modules for accessing the wireless communication network 100. The UEs 110 and 112 may each be implemented as a terminal device including but not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. As shown in FIG. 2, each of the UEs such as UE 112 may include transceiver circuitry 206 coupled to one or more antennas 208 to effectuate wireless communication with the WANN 120 or with another UE such as UE 110. The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the methods described herein.

Similarly, the WANN 120 may include a wireless base station or other wireless network access point capable of communicating wirelessly via the over-the-air interface 204 with one or more UEs and communicating with the core network 130. For example, the WANN 120 may be implemented, without being limited, in the form of a 2G base station, a 3G nodeB, an LTE eNB, a 4G LTE base station, a 5G NR base station of a 5G gNB, a 5G central-unit base station, or a 5G distributed-unit base station. Each type of these WANNs may be configured to perform a corresponding set of wireless network functions. The WANN 202 may include transceiver circuitry 214 coupled to one or more antennas 216, which may include an antenna tower 218 in various forms, to effectuate wireless communications with the UEs 110 and 112. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions of the WANN 120 described herein.

Data packets in a wireless access network such as the example described in FIG. 2 may be transmitted as protocol data units (PDUs). The data included therein may be packaged as PDUs at various network layers wrapped with nested and/or hierarchical protocol headers. The PDUs may be communicated between a transmitting device or transmitting end (these two terms are used interchangeably) and a receiving device or receiving end (these two terms are also used interchangeably) once a connection (e.g., a radio link control (RRC) connection) is established between the transmitting and receiving ends. Any of the transmitting device or receiving device may be either a wireless terminal device such as device 110 and 120 of FIG. 2 or a wireless access network node such as node 202 of FIG. 2. Each device may both be a transmitting device and receiving device for bi-directional communications.

The core network 130 of FIG. 1 may include various network nodes geographically distributed and interconnected to provide network coverage of a service region of the carrier network 102. These network nodes may be implemented as dedicated hardware network nodes. Alternatively, these network nodes may be virtualized and implemented as virtual machines or as software entities. These network nodes may each be configured with one or more types of network functions which collectively provide the provisioning and routing functionalities of the core network 130.

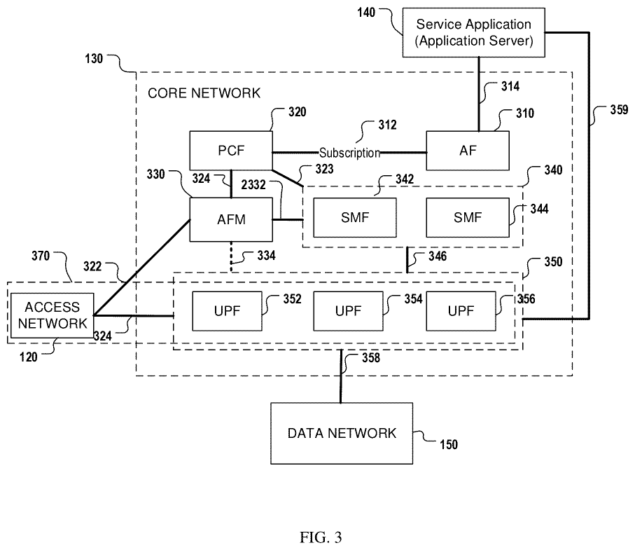

FIG. 3 shows an example division of network node functions in the core network 130. While only single instances of network nodes for some functions are illustrated in FIG. 3, those having ordinary skill in the art understand that each of these network nodes may be instantiated as multiple instances that are distributed throughout the core network 130. As shown in FIG. 3, the core network 130 may include but are not limited to access management network function (AMF) nodes 330, session management function (SMF) nodes 340, user plane function (UPF) nodes 350, policy control function (PCF) nodes 320, and application data management function (AF) nodes 310.

The AMF nodes 230 may communicate with the access network 120, the SMF nodes 340, and the PCF nodes 320 respectively via communication interfaces 322, 332, and 324, and may be responsible for provisioning registration, authentication, and access by the UE to the core network 130 was well as allocation of SMF nodes 340 to support particular UE communication sessions. The SMF nodes 340 allocated by the AFM nodes 330 may in turn may be responsible for allocating UPF nodes 350 for supporting the particular UE communication session and control these allocated UPF nodes 350 via communication interface 346. Alternatively, or additionally in some implementations, the UPF nodes 350 may be directly allocated by the AMF nodes 330 via the interface 334 and controlled by the SMF nodes 340 via the communication interface 346. Access policies and session routing policies applicable to the UEs may be managed by the PCF nodes 320 which communicate the policies to the AMF nodes 330 and the SMF nodes 340 via communication interfaces 324 and 323, respectively. The PCF nodes 320 may be further responsible for managing user subscription 312 to service application 140 via the AF nodes 310. The signaling and data exchange between the various types of network nodes through various communication interfaces indicated by the various connection lines in FIG. 3, may be carried by signaling or data messages following predetermined types of format or protocols.

To support a particular end-to-end communication task requested by a UE, a communication session may be established to support a data traffic pipeline for transporting the particular end-to-end data communication traffic. The carrier network portion of the data traffic pipeline, as illustrated by 370 of FIG. 3, may involve one or more network nodes in the access network 120 and a set of UPF nodes 352, 354, and 356 in the core network 130, as selected and controlled, for example, by a set of SMF nodes 342 and 344 which may be selected and controlled by the AMF nodes 330 that are responsible for establishing and managing the communication session. Data traffic is routed among a UE at one end of the data traffic pipeline, the carrier network portion of the data traffic pipeline (including the set of network nodes in the access network 120 and the selected UPF nodes 352, 354, and 356 in the core network 130), and another end of the data traffic pipeline including, for example, another UE, a service application or application server 140, or a data network 150, via communication interfaces such as 324, 358, and 359.

For some communication sessions, data transmitted in the core network 130 may terminate on the application server 140. In other words, the application server 140 may be a destination of data traffic routed in the core network 130. Likewise, the application server 140 may also be source of data traffic to be routed by the core network 130 to other destinations. In such a communication session, the application server 140 may be accessed by the carrier network portion 370 of the data traffic pipeline for the communication session, as indicated by 359. The communication pipelines 370 for data traffic may be referred to as a user plane (UP) of the carrier network 130, whereas the other core network functions are referred to as being part of a control plane (CP) of the carrier network 130. The separation of the UP and CP of the carrier network 130 may facilitate efficient resource management, configuration, control, and usage.

The application server 140 may further communicate other configuration and control information to the core network 130. The information communicated to the core network 130 may be referred to as application data. Such application data may be processed and managed by AF nodes 310 in FIG. 2. The application data may be communicated, for example, in a message from the application server 140 to the AF network nodes 310 via communication interface 314. Alternatively, the application server 140 may access the AF nodes 310 using open APIs provided by the core network 130. While FIG. 2 only shows a single application server, those having ordinary skill understand that in practical implementations, the core network 130 may supporting a plurality of service applications of different types.

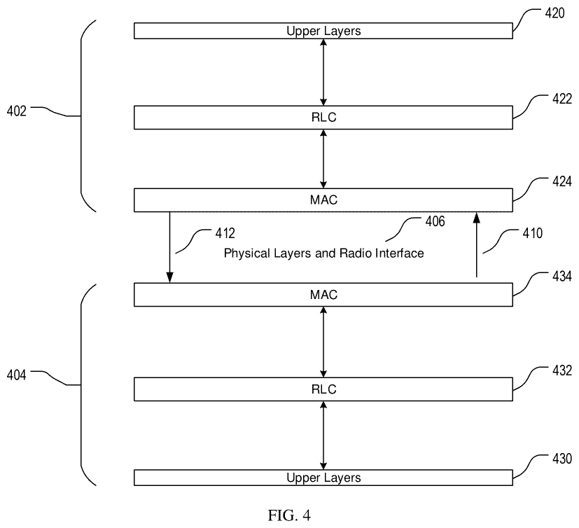

FIG. 4 further illustrates a simplified view of the various network layers involved in transmitting user-plane PDUs from a transmitting device 402 to a receiving device 404 in the example wireless access network of FIGS. 1-3. FIG. 4 is not intended to be inclusive of all essential device components or network layers for handling the transmission of the PDUs. FIG. 4 illustrates that the data packaged by upper network layers 420 at the transmitting device 402 may be transmitted to corresponding upper layer 430 (such as radio resource control or RRC layer) at the receiving device 304 via Packet Data Convergence Protocol layer (PDCP layer, not shown in FIG. 4) and radio link control (RLC) layer 422 and of the transmitting device, the physical (PHY) layers of the transmitting and receiving devices and the radio interface, as shown as 406, and the media access control (MAC) layer 434 and RLC layer 432 of the receiving device. Various network entities in each of these layers may be configured to handle the transmission and retransmission of the PDUs.

In FIG. 4, the upper layers 420 may be referred as layer-3 or L3, whereas the intermediate layers such as the RLC layer and/or the MAC layer and/or the PDCP layer (not shown in FIG. 4) may be collectively referred to as layer-2, or L2, and the term layer-1 is used to refer to layers such as the physical layer and the radio interface-associated layers. In some instances, the term “low layer” may be used to refer to a collection of L1 and L2, whereas the term “high layer” may be used to refer to layer-3. The term “lower layer” may be used to refer to a layer among L1, L2, and L3 that are lower than a current reference layer. Control signaling may be initiated and triggered at each of L1 through L3 and within the various network layers therein. These signaling messages may be encapsulated and cascaded into lower layer packages and transmitted via allocated control or data over-the-air radio resources and interfaces. The term “layer” generally includes various corresponding entities thereof. For example, a MAC layer encompasses corresponding MAC entities that may be created. The layer-1, for example, encompasses PHY entities. The layer-2, for another example encompasses MAC layers/entities, RLC layers/entities, service data adaptation protocol (SDAP) layers and/or PDCP layers/entities.

### AI in Wireless Network Configuration

At the core of a general AI network management framework are various AI models. An AI model generally contains a large number of model parameters that are determined through a training process where correlations in a set of training data are learned and embedded in the trained model parameters. The trained model parameters may thus be used to generate inference from a set of input datasets that may not have existed in the training datasets. AI models are particularly suitable for situations where there is few trackable deterministic, rule-based, or analytical derivation paths between input data and output.

In a wireless communication system such as the ones described above, determination of adaptive network configuration may rely on empirical characteristics and my further require lengthy measurement processes and/or significant amounts of computation power. Such types of configurations may include but are not limited to over-the-air interface beam management, channel state information (CSI) feedback compression and decompression, and wireless terminal positioning. Correlation between various network conditions and these adaptive configurations may be leaned via AI techniques. The use of AI models for assisting in network configuraiton may thus help reduce the amount of measurements and computation requirement, providing a more agile network configuration. Accordingly, it may thus be desirable to provide a mechanism for provisioning a lifecycle of various AI models and the applications in assisting in the adaptively determining these network configurations. A particular critical aspect of the AI model life cycle includes delivery and transfer of the AI models between the various network nodes described above.

For example, AI technology may be applied to beam management in the over-the-air communication interface. In current implementations, beam management typically relies on the exhaustive searching beam sweeping. In other words, the network (NW) may perform a full sweep of the beams by sending sufficient number of reference signals. A UE may be configured to monitor and measure each reference signal and then report the measurement result to NW for the NW to decide the best beam for the UE to switch to. This process, however, is resource and power intensive. With trained AI models that embed learned correlation between various network condition parameters, few measurements (or fewer reference signals) may be needed in order to accurately infer the best beams. In some implementations, AI model may help identify inference of best candidate beams using other network conditions and then only sweep and measure the candidate beams to select the beam for use in current communication. Additionally, as beam configuration is closed tied to a location of the UE, AI technology may further be used for inferring or predicting UE trajectory or location, thereby indirectly help selection of best beams.

For another example, AI technology may be applied to channel state information (CSI) feedback. Traditionally, the CSI feedback may be implemented using a codebook known by UE and NW. The UE may measure the CSI and obtain a measurement result, and then map the measurement result to a closest vector of the codebook, and transmit the index of that vector to the NW in order to save the air-interface resource consumption. However, because the codebook is not unlimited or dynamic changeable over time, there would be always mismatch, thereby causing un-controlled CSI feedback errors as the wireless environment varies. AI thus may be applied to compression-decompression for CSI feedback. Specifically, a CSI report may be compressed by a UE-side AI model and decompressed by a corresponding NW-side AI model. Such AI models may be initially trained and continuously developed over time and accumulation of network conditions.

For yet another example, AI technology may be applied to UE positioning. Traditional approaches for UE positioning depend on PRS or SRS (e.g. DL Positional Reference Signal and uplink Sounding Reference Signal). Regardless of the alternative approaches, the LOS (Line-Of-Sight) beams are the key beams to identify in order to generate the most precise location estimation by triangulation at the NW side. However, in most case, it is difficult to identify the LOS beams from other NLOS (Non-Line-Of-Sight) beams, thereby providing in accurate UE positioning. A trained AI model, on the other hand, may identify various pattern and correlation in the PRS and SRS for extracting LOS information and providing more accurate UE positioning.

These AI models may be trained and managed at the various network nodes described above, and may need to be delivered or transferred to another network nodes. For example, in some circumstances, AI models may need to be transferred between a UE and a data network as shown in FIGS. 1 and 3 in either uplink (UL) or downlink (DL) communication direction. In those situations, the transfer of the AI model may be implemented by considering the AI model transmission as regular data transmission and thus may take advantage of the normal PDU session requisition, resource allocation, and establishment procedures. In some other example circumstances, AI models may need to be transferred between a UE and a wireless base station as endpoints as shown in FIG. 1 ad 2 or between a UE and a core network node as endpoints and via a base station as shown in FIGS. 1 and 3 in either UL or DL communication directions. The disclosure below provides example embodiments for interactive procedures among various network nodes in the wireless communication network for resource requisition, allocation, and management for the transfer of AI network management models in either CP, UP, or both CP and UP of the network.

### AI Network Management Model Transfer Between UE and Base Station as Endpoints

In some example circumstances, AI models trained and/or managed at a UE may need to be transferred to a base station, and vice versa. Such AI model transfers may be carried in the air interface. The communication resources in the air interface may generally include a plurality of radio bearers (RB) resources. In some example implementations, such RB resources between the UE and the base station, being either UL RBs, or DL RBs, or bi-direction RBs, may be further managed and allocated as separate categories of Signaling RB (SRB) resources or Data RB (DRB) resources. An SRB resource, for example, may be allocated to carrier signaling and control information whereas a DRB resource may be allocated to carrier data information. Accordingly, either SRB or DRB resources may be allocated for the transfer of an AI network management model.

An allocation of the SRB by the base station generally do not require an establishment of a PDU session and thus may not need involve the core network. As such, existing radio resource request and allocation schemes of existing wireless network may be used for the transfer of the AI network management models between the UE and the base station over SRB resources without involving the core network. However, because DRB allocations in existing network management schemes generally involve transmission of data in the user plane (UP) of the core network, they are thus tied to one or more PDU sessions. The base station, without involving the core network in performing various procedures in order to establish and specify one or more PDU sessions, may not be able to allocate any DRB resources for the transfer of the AI network management models between the UE and the base station following the DRB resource allocation schemes in the existing network.

The various example embodiments below describe schemes (1) in which SRB resources are requested and allocated for the transfer of AI network management model between the UE and the base station without involvement of any core network node, (2) in which DRB resources are requested and allocated in new procedures that do not involve of any core network node for the transfer of AI network management model between the UE and the base station, and (3) in which DRB resources are requested and allocated with the core network involved in establishing one or more PDU sessions for the transfer of the AI network management models but with none of the model transfer endpoints in the core network (the AI model transfer endpoints being at the UE and the base station, both outside of the core network).

Further in the various embodiments below, either the UE or the base station can be the requesting device for the AI model transfer, and the AI model transfer can be in either the UL direction or the DL direction, giving rise to four different scenarios:
S1: the base station requests a UL AI model transfer from UE;
S2: the UE requests a DL AI model transfer from the base station;
S3: The UE requests a UL AI model transfer to the base station; or
S4: The base station requests a DL AI model transfer to the UE.

### Implementations Based on SRB or DRB Resources in the Air Interface Without CN Involvement

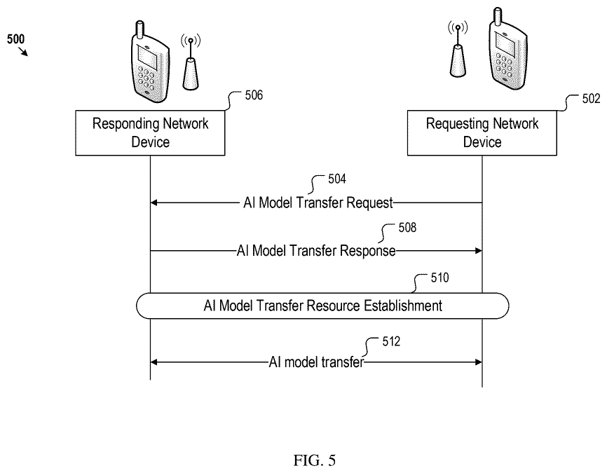

FIG. 5 illustrates an example general procedure 500 for initiating, triggering an AI model transfer terminated between a UE and a base station without involvement of the core network. This example procedure generally applies to all scenarios above (scenarios S1 through S4 above with respect the which one of the UE and the base station acts as a requestor or a responder for the AI model transfer and which one acts as a model origin or destination).

The procedure 500 of FIG. 5 involves a requesting network device 502 and a responding network device 506 for the AI model transfer first implementing a requesting-responding procedure. The requesting network device 502 may be one of the UE and the base station, whereas the responding network device 506 may be the other of the UE and the base station. The requesting network device 502, either being the UE or the base station, may be either the origin or the destination of the AI model being transferred and thus may act as an AI model origin network device to transmit the AI model or as a model destination network device to receive the AI model. Likewise, the responding network device 506, either being the UE or the base station, may also be either the original or the destination of the AI model being transferred and thus may act as an AI model origin network device to transmit the AI model or as a model destination network device to receive the AI model.

The general procedure 500 of FIG. 5 may include:
Transmitting by the requesting network device 502 an AI model transfer request 504 to the responding network device 506.
Receiving by the responding network device 506 the model transfer request 504 and transmitting by the responding network device 506 an AI model transfer response 508 to the requesting network device 502.
Establishing network resources in 510 (for the air interface, in particular) for the AI model transfer.
Transferring the AI network management model from the AI model origin device (one of the requesting network device and the responding network device) to the AI model destination network device (the other one of the requesting network device and the responding network device), as shown by 512 with double arrow indicating either of the UP or DL transfer direction.

### SRB-Based Implementations

In some example implementations, the radio resources in the air interface allocated for the transfer of the AI network management model in 510 may be one or more SRB resources. Such implementations may include the following example steps:
STEP 1: The requesting network device 502 may generate and send the AI model transfer request 504 to the responding network device 506 according to an AI based function associated with the AI model to be transferred (e.g., beam management functions, CSI report functions, and locationing functions).

In some example implementations, the AI model transfer request 504 may be transmitted in a form of a UL or DL RRC message. In some alternative implementations, the AI model transfer request 504 may be transmitted in a form of a UL or DL MAC Control Element (MAC CE).

In some other example implementations, both RRC Message and MAC CE may be used as available and allowable form for transmitting the AI model transfer request 504. Either one of these forms may be selected by the requester device 502 according to whether previous SRB resources have been established for AI model transfer. For example, if no previous SRB resource has been established for AI model transfer, the requesting network device 502 may determine that a UL or DL RRC message may be used to transmit the AI model transfer request 504. Otherwise, if one or more previous SRB resources have been established for AI model transfer, the requesting network device 502 may determine that a DL or UL MAC CE should be used to transmit the AI model transfer request 504.

In some example implementations, when the requesting network device 502 determines that an UL MAC CE is to be used for transmitting the AI model transfer request 504, and if the AI model transfer request has been triggered and pending and there no available PUSCH resources for accommodating the MAC CE, then a Scheduling Request (SR) may be triggered for a scheduling of PUSCH resources for the MAC CE.

In some example implementations, a DL RRC Message may be used for transmitting the AI model transfer request 504 (in the situation the requesting network device 502 is the base station), the AI model transfer request may include a DL RRC reconfiguration message by the base station to add one or more SRB resource allocation for the AI model transfer. Such SRB resource may be added separately from other existing types of UL, DL, or bi-direction SRBs. For example, SRB type 5 may be added on top of normal SRB types 1 to 4. The added UL, DL or bi-direction SRBs may be dedicated to AI model transfer between the UE and the base station. Allocation of dedicated SRBs for AI model transfer may be advantageous because of the distinct characteristics and requirements for AI model transfer (e.g., the amount of data, the reliability of the transfer, the delay tolerance) in comparison to other signaling information normally transmitted in SRB resources. Dedicating SRBs for the transfer of AI network management model also help minimize degrading transmission of other signaling information in the existing SRBs.

In some example implementations, the AI model transfer request 504 may include at least one of the following information (in either an UL AI Model transfer request, or a DL AI model transfer request, in the form of either an RRC message or a MAC CE):
An AI based function indication to indicate an AI based function to which the AI model to be transferred belonging to (the AI based function may be one of, e.g., AI based beam management function, AI based CSI enhancement function, AI based positioning enhancement function).
An AI model identification or identifier to indicate the requested AI model. Such identifier may be an AI model ID, or an AI model description that may be used to identify the AI model to be transferred.

In some example implementations, if the AI model transfer request 504 is a DL RRC Message, it may further include an SRB indicator or identifier to specify the SRB resource(s) that is to be used for the transfer of the AI network management model when existing SRB resources rather than new SRBs are to be used for AI model transfer. In some example implementation, the AI model transfer Request 504 may implicitly indicate that the SRB being used for sending the AI model transfer Request 504 is the SRB for the transfer of the AI network management model.

In some example implementations, when an RRC message is used for the transmission of the AI model transfer request 504 and when the one or more SRB resources to be used for the transfer of the requested AI model are shared with existing signaling information, the AI model transfer request 504 may further include an RRC transaction identifier for indicating the RRC procedure associated with the AI model transfer request, such that it is distinguishable from other RRC messages for transmitting signaling information in the shared SRBs in order to provide differential treatment of the AI model transfer and the other signaling information if needed.
STEP 2: The responding network device 506 may respond to the requesting network device 502 with the AI model transfer response 508 when the AI model transfer request 504 is received and accepted.

In some example implementation, the AI model transfer response 508 may be a UL RRC message (the UE being the responding network device and the base station being the requesting network device) or DL RRC message (the base station being the responding network device and the UE being the requesting network device). The UL or DL RRC message may indicate a confirmation (ACK) or rejection (NACK) to the AI model transfer request 504. If the UL or DL RRC message contains a rejection, it may further include information regarding one or more reasons for the rejection.

In some example implementation, if the AI model transfer response 508 is a DL RRC message (the NW being the responding network device and the based station being the requesting network device), the AI model transfer response 508 may further include an SRB indicator or identifier to specify the SRB resource(s) that is to be used for the transfer of the AI network management model when existing SRB resources rather than new SRBs are to be used for the AI model transfer.

In some alternative example implementations, the AI model transfer response 508 may be a UL MAC CE (the UE being the responding network device and the base station being the requesting network device) or a DL MAC CE (the base station being the responding network device and the UE being the requesting network device). The UL or DL MAC CE may indicate a confirmation (ACK) or rejection (NACK) to the AI model transfer request 504. If the UL or DL MAC CE message contains a rejection, it may further include information regarding one or more reasons for the rejection.

In some example implementations, when the AI model transfer request 504 is an RRC reconfiguration message for the configuration of dedicated SRB resources(s) for the transfer of the AI network management model, the AI model transfer response 508 may correspondingly be an RRC-Reconfiguration-Completion Message for indicating an acknowledgement or establishment of the SRB resource(s).

In some example implementations, when the model transfer request 504 is an UL RRC message or UL MAC CE (from UE to the base station), the AI model transfer response 508 may be an RRC reconfiguration message from the base station to the UE for requiring the UE to establish one or more dedicated SRB resources for the transfer of the AI network management model.

In some example implementations, When the model transfer request 504 is an DL RRC Message (from base station to the UE) which may contain an RRC reconfiguration message to establish one or more dedicated SRB resources for transfer of the AI network management model, the AI model transfer response 508 may correspondingly be an RRC-Reconfiguration-Completion Message for indicating an acknowledgement or an establishment of the SRB resource(s).
STEP 3: The base station may initiate an RRC reconfiguration procedure to establish one or more new SRB resources if the AI model transfer request is confirmed and the SRB have not been previously configured. In the case that the AI model transfer request is transmitted from the base station to the UE in an RRC reconfiguration message, that request message act to initiate the RRC reconfiguration procedure for establishing the new SRB resources. For use of already allocated SRB(s) for the AI model transfer, then no RRC reconfiguration is needed.
STEP 4: The origin network device (either the UE or the base station, as either the requesting network device or responding network device) may start transferring the requested AI network management model via the allocated or newly established SRB resource(s) to the destination network device (either the base station or the UE, as either the requesting network device or responding network device).

### DRB-Based Implementations

In some example implementations, the radio resources in the air interface allocated for the transfer of the AI network management model in 510 of FIG. 5 may be one or more DRB resources. Such implementations may include the following example steps:
STEP 1: the requesting network device 502 may generate the model transfer Request 504 and transmit the request to the responding network device 506 according to an AI based function associated with the AI model to be transferred.

In some example implementation, the Model Transfer Request 504 may be transmitted in a form of a UL or DL RRC Message. In some other implementations, the AI model transfer request may be transmitted in a form of a UL or DL MAC CE.

In some other example implementations, as in the SRB cases above, both RRC Message and MAC CE may be used as available and allowable form for transmitting the AI model transfer request 504. Either one of these forms may be selected by the requester device 502 according to whether previous DRB resources have been established for AI model transfer. For example, if no previous DRB resource has been established or there is no available DRB resources for AI model transfer, the requesting network device 502 may determine that a UL or DL RRC message may be used to transmit the AI model transfer request 504. Otherwise, if one or more previous DRB resources have been established for AI model transfer, the requesting network device 502 may determine that a DL or UL MAC CE should be used to transmit the AI model transfer request 504.

In some example implementations, when the requesting network device 502 determine that an UL MAC CE is to be used for transmitting the AI model transfer request 504, and if the AI model transfer request has been triggered and pending and there no available PUSCH resources for accommodating the MAC CE, then a Scheduling Request (SR) may be triggered for a scheduling of PUSCH resources for the MAC CE.

In some example implementations, the AI model transfer request 504 may include at least one of the following information (in either an UL AI Model transfer request, or a DL AI model transfer request, in the form of either an RRC message or a MAC CE):
An AI based function indication to indicate an AI based function to which the AI model to be transferred belonging (the AI based function may be one of, e.g., AI based beam management function, AI based CSI enhancement function, AI based positioning enhancement function).
An AI model identification or identifier to indicate the requested AI model. Such identifier may be an AI model ID, or an AI model description that may be used to uniquely identify the AI model to be transferred.
A DRB indicator or identifier to indicate the DRB resources that may be used for the transfer of the AI network management model.
A PDU Session indicator or identifier to indicate the PDU session that may be used for the transfer of the AI network management model.
A QoS flow indicator or identifier to indicate the QoS flow that is associated with the PDU sessions which are indicated by the present PDU Session indicator or identifier as may be used for the transfer of the AI network management model.

In some example implementations, in the case that the model transfer request is a DL RRC Message, the DL RRC Message may be or may contain RRC Reconfiguration message configuring a DRB to be used for the transfer of the AI network management model. In one implementation of the DRB for the transfer of the AI network management model, the RRC Reconfiguration Message may be used to add/modify a DRB that is only used for the transfer of the AI network management model. In another implementation, the RRC Reconfiguration Message may be used to add/modify a DRB that can be used for both the transfer of the AI network management model and also associated with a PDU session via SDAP-Config.

In some example implementations, when an RRC message is used for the transmission of the AI model transfer request 504 and when the one or more SRB resources to be used for the transfer of the requested AI model are shared with existing signaling information, the AI model transfer request 504 may further include an RRC transaction identifier for indicating the RRC procedure associated with the AI model transfer request, such that it is distinguishable from other RRC messages for transmitting signaling information in the shared SRB in order to provide differential treatment of the AI model transfer request and the other signaling information if needed.
STEP 2: The responding network device 506 may respond to the requesting network device 502 with the AI model transfer response 508 when the AI model transfer request 504 is received and accepted.

In some example implementation, the AI model transfer response 508 may be a UL RRC message (the UE being the responding network device and the base station being the requesting network device) or DL RRC message (the base station being the responding network device and the UE being the requesting network device). The UL or DL RRC message may indicate a confirmation (ACK) or rejection (NACK) to the AI model transfer request 504. If the UL or DL RRC message contains a rejection, it may further include information regarding one or more reasons for the rejection.

In some alternative example implementations, the AI model transfer response 508 may be a UL MAC CE (the UE being the responding network device and the base station being the requesting network device) or a DL MAC CE (the base station being the responding network device and the UE being the requesting network device). The UL or DL MAC CE may indicate a confirmation (ACK) or rejection (NACK) to the AI model transfer request 504. If the UL or DL MAC CE message contains a rejection, it may further include information regarding one or more reasons for the rejection.

In some example implementations, when the AI model transfer response 508 is a UL RRC Message (i.e., from UE to NW), the AI model transfer response may be or may contain an RRC Reconfiguration Completion Message for indicating an ACK or establishment of the specific DRB resource(s)

In some example implementation, when the AI model transfer response 508 is a DL RRC Message (i.e., from the network to UE), the AI model transfer response may be or may contain an RRC Reconfiguration Message for establishing and/or configuring the DRB resources for AI model transfer.

In some example implementations, the AI model transfer response 508 may contain at least one of one or more PDU Session identifiers associated with one or more PDU sessions to be used for the transfer of the AI network management model, one or more QFI associated with the one or more QoS flows to be used for the transfer of the AI network management model, and/or one or more DRB IDs to indicate the air interface DRB resources to be utilized for the transfer of the AI network management model.
STEP 3: The base station may initiate an RRC reconfiguration procedure to establish one or more new DRB resources if the AI model transfer request is confirmed and the DRB for the transfer of the AI network management model have not been previously configured.

In some example implementations of configuring one or more specific DRB resources, the one or more DRB resources may be dedicated to AI model transfer. Such RRC configuration for the DRB resources may include one or more flags in the DRB configuration (i.e. RadioBearerConfig) to indicate that one or more DRB resources are established for AI model transfer. In an alternative implementation, such flags may be present in an SDAP configuration (i.e. SDAP-Config) associated with the DRB resources. In another alternative implementation, such flags may be present in a PDCP configuration (i.e. PDCP-Config) associated with the DRB resources. In yet another alternative implementation, such flags may be present in an RLC configuration (i.e. RLC-Config) associated with the DRB resources. In other words, the one or more flags for indicating the one or more DRB resources may be placed at various levels in the radio bearer configuration stack.

In some example implementations, SDAP-Configuration may be absent in the RRC configuration of the DRB resources for AI model transfer, in other word, the DRB resource for the transfer of the AI network management may be not associated with any PDU session and/or QoS flow.

In some example implementations, an RLC mode of an RLC entity associated with the DRB resources for the transfer of the AI network management may be set to Acknowledgement Mode (AM) to guarantee reception of the AI network management model.

In some example implementations, when the SDAP configuration is present in the RRC configuration associated with the DRB for AI model transfer (e.g., within the radiobearerConfig of the RRC configuration), the PDU session ID may be left absent in the SDAP configuration, as the AI model transfer is between the UE and the base station and thus need not to rely on any PDU sessions.

In some example implementations, rather than using dedicate DRB for the transfer of the AI model, legacy DRB resources may be configured for AI model transfer. At least one of the following may be included in configuring such DRB resources:
An indicator bit in a header of the SDAP or PDCP or RLC PDU to indicate that the corresponding PDU is for AI model transfer; or
One or more QFIs among a special QFI list in the SDAP-Config to indicate the data with such QoS flow(s) is for AI model transfer, the special QFI list being introduced to distinguish regular data transfer and the AI model transfer (e.g., use mappedQoS-FlowsForModelTransferToAdd to construct the special QFI list). In such implementations, the UL or DL SDAP header where the QoS flow ID is present may be configured to be present.
STEP 4: The origin network device (either the UE or the base station, as either the requesting network device or responding network device) may start transferring the requested AI network management model via the allocated DRB resource(s) to the destination network device (either the base station or the UE, as either the requesting network device or responding network device) via the DRB resources for the transfer of the AI network management model.

### Implementations Based on DRB Resources in the Air Interface with CN Involvement

In some implementations in which an AI network management model is to be transferred between the UE and the base station, the configuration of the air interface resources may involve the core network.

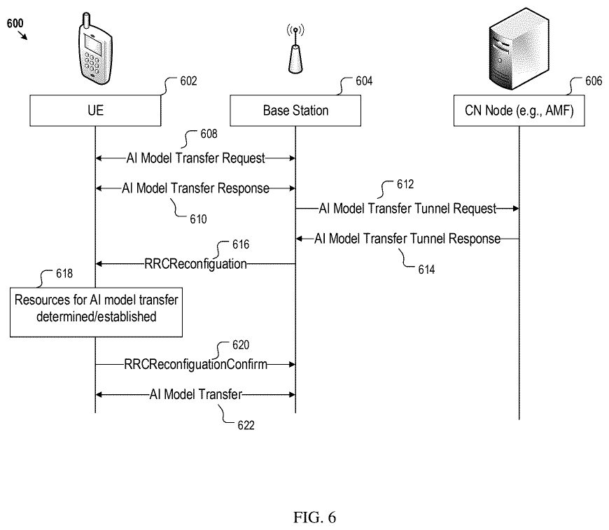

An example for a general implementation is shown in the flow diagram 600 in FIG. 6. In FIG. 6, a requesting network device (UE 602 or base station 604) may transmit an AI model transfer request 608 to a responding network device (either the base station 604 or the UE 602). The responding network device may send an AI model transfer response 610 upon receiving the AI model transfer request 608. The AI request response 610 may be optional when the UE is the AI model transfer requester. In that situation, the response to the UE may be delayed after the base station successfully interacted with the core network for configuring the communication resources for the transfer of the AI model (e.g., the response may be effectively achieved by the RRC reconfiguration message 616 described below).

The interaction between the UE and the base station in 608 and 610 may be referred to as an AI model transfer request-response procedure. Either one of the UE or the base station may be the requesting network device, and the other one of the UE or the base station may be the responding network device. In the situation where the UE is the requester and no immediate response to the AI model transfer request is sent back to the UE, the corresponding procedure without the response may be referred to as an AI model requisition procedure.

As shown in FIG. 6, following the AI model transfer request-response procedure or requisition procedure, the base station 604 may initiate an AI model transfer tunnel request 612 with a CN node, e.g., an AMF node 606, followed by an AI model transfer tunnel response 614 transmitted from the CN node 606 to the base station 604. The base station 604, upon receiving the AI model transfer tunnel response 614, and if CN node 606 authorize the requested tunnel, may perform network configuration, e.g., by generating and transmitting an RRC reconfiguration message 616 to the UE 602. The UE then determine and establish communication resources in the air interface for the AI model transfer according to the RRC reconfiguration message, as shown by 618 of FIG. 6, and communicate a confirmation of the RRC reconfiguration 620 to the base station 604. Thereafter, the requested AI network management model may be transferred between the AI model origin device and the AI model destination device in 622. The origin AI device may either the UE or the base station. Correspondingly, the destination AI device may be the base station and the UE.

The example implementation of FIG. 6 essentially takes advantage of a data tunnel request and establishment procedure between the wireless base station 604 and the core network and use the radio resource associated with the data tunnel so established to transfer the AI network management model between the UE 602 and base station 604 as the endpoints of the AI model transfer. Because the implementation FIG. 6 involves the CN for a utilization of CN-assisted data tunnel, DRB resources in the air interface between the UE 602 and the base station 604 may be used as the radio resources for the transfer of the requested AI network management model.

The general implementation of FIG. 6 may be carried out in the following steps.
STEP 1: The requesting network device (either the UE 602 or the base station 604) transmits the AI model transfer request 608 to the responding network device (either the base station 604 or the UE 602). The request may be associated with one or more AI based network management functions (e.g., beam management functions, CSI report functions, and locationing functions, etc.).

In some example implementations, the AI model transfer request 608 may be transmitted in a form of a UL or DL RRC message. In some alternative implementations, the AI model transfer request 504 may be transmitted in a form of a UL or DL MAC Control Element (MAC CE).

In some example implementations, both RRC Message and MAC CE may be used as available and allowable form for transmitting the AI model transfer request 608. Either one of these forms may be selected by the requester device (either the base station or the UE) according to whether previous data tunnels or resources have been established for AI model transfer. For example, if no previous data tunnels or resources have been established or configured for AI model transfer, the requesting network device may determine that a UL or DL RRC message may be used to transmit the AI model transfer request 606. Otherwise, if one or more previous data tunnels or resources have been established or configured for AI model transfer, the requesting network device may determine that a DL or UL MAC CE should be used to transmit the AI model transfer request 608. The previously available resources may be one or more DRBs, one or more QoS flows of PDU sessions, or one or more PDU sessions that is indicated by a configuration to be used for AI model transfer.

In some example implementations, when the AI model transfer request 608 is a UL RRC Message (UE being the requesting network device), such RRC message may include a non-access stratum (NAS) container encompassing a request message as an AI model transfer tunnel request for requesting the data tunnel for the AI model transfer. The NAS request message, for example, may be destined to the core network node 606 in the control plane (CP) and may be transparent to the base station 604. In some example implementations, when data tunnel(s) is already available for the AI model transfer, then the NAS message container may be absent.

In some example implementations, the AI model transfer request 608 (either UL from the UE to the base station, or DL from the bae station to the UE, being wither RRC message or MAC CE) may include at least one of:
a request message as an AI model transfer tunnel request for requesting the data tunnel for the AI model transfer. And there may be a flag in such request to indicate that the tunnel is requested for the AI model transfer. In one example implementation, such request message may be present in a a non-access stratum (NAS) container which is transparent to gNB.
An AI based function indication to indicate an AI based function to which the AI model to be transferred belonging to (the AI based function may be one of, e.g., AI based beam management function, AI based CSI enhancement function, AI based positioning enhancement function).
An AI model identification or identifier to indicate the requested AI model. Such identifier may be an AI model ID, or an AI model description that may be used to request the other endpoint to determine or search for a matched AI model to be transferred.
An AI model information to indicate the information about the requested AI model, for example, AI model size, etc.

In some example implementations, the AI model transfer request 608 may be a UL RRC Message (e.g., UE being the requesting network device), and may further include an endpoint IP address for the UE for the AI model transfer (the UE being either the AI model origin device or the AI model destination device). Such endpoint IP address of the UE may be used by the core network to identify or find UPF associated with data tunnel to be allocated for the transfer of the AI network management model.

In some example implementations, the AI model transfer request 608 may be a UL or DL MAC CE. In cases where data tunnels may have been available for the transfer of the AI model, such UL or DL MAC CE may further include at least one of the following for the MAC CE request message to identify aspects of the available data tunnel:
One or more PDU session identifiers to indicate one or more PDU sessions that are to be used for the requested AI model transfer.
One or more QoS Flow identifiers to indicate one or more QoS flows that are used for transferring the requested AI model.
One or more DRB identifiers to indicate one or more DRB resources that are used for transferring the requested AI model.
An AI based function indication or identifier to indicate an AI based function to which the AI model to be transferred belonging to (the AI based function may be one of, e.g., AI based beam management function, AI based CSI enhancement function, AI based positioning enhancement function).
An AI model identification or identifier to indicate the requested AI model. Such identifier may be an AI model ID.
An AI model information to indicate the information about the requested AI model, for example, AI model size, etc.
An Endpoint of the Ip Address of the UE.
STEP 2: The responding network device among the UE or the base station may generate the AI model transfer response 610. Such a response may correspondingly be either an RRC message or a MAC CE. As described above, such an immediate response from the base station to the UE may be optional.

In some example implementations, when the AI model transfer response 610 is a UL RRC Message (UE being the responding network device), such RRC message may include a NAS container encompassing a request message as an AI model transfer tunnel request for requesting the data tunnel for the AI model transfer. As described above, the NAS request message, for example, may be destined to the core network node 606 in the control plane (CP) and may be transparent to the base station 604.

In the case that the response 610 is an UL RRC message, it may further include at least one of
a request message as an AI model transfer tunnel request for requesting the data tunnel for the AI model transfer. And there may be a flag in such request to indicate that the tunnel is requested for the AI model transfer. In one implementation, such request message may be present in a a non-access stratum (NAS) container which is transparent to gNB.
An identifier for indicating a base AI function associated with the AI network management model.
A confirmation to the AI model transfer request.
An endpoint of the IP address of the UE.
A failed confirmation to the AI model transfer request.
One or more reasons for the failed confirmation.

In some example implementations, when the AI model transfer response 610 is a UL or DL MAC CE, such a MAC CE response may contain at least one of the following fields:
An identifier for indicating the AI based function to which the confirmed AI model to be transferred belongs.
An AI model identifier to indicate the AI model that is confirmed.
One or more PDU session identifiers to indicate one or more PDU session with which the AI model transfer is to be performed
One or more DRB identifiers to indicate one or more DRB resources with which the AI model transfer is to be performed.
One or more QFIs to indicate one or more QoS flows with which the AI model transfer is to be performed
STEP 3: Following the AI model transfer request-response procedure above, the base station 604 may then generate and/or forward the AI model transfer tunnel request 612 to the core network node 606, such as an AMF, for acquiring the model transfer tunnels according to the AI model transfer request 608.

In some example implementations, the AI Model Transfer Tunnel Request may be a request of one or more QoS flows of the PDU session from the AMF and may include at least one of the following:
An AMF UE NGAP (NG Application Protocol) identifier to indicate the UE specific AMF ID via an NGAP interface.
A RAN UE NGAP identifier to indicate the UE specific RAN ID via the NGAP interface.
One or more PDU session identifiers associated with the requested QoS flows.
A number of requested QoS flows for each of the one or more PDU sessions.
The number of the requested AI network management models.
A size of each requested AI network management model.
One or more QoS requirements related to one or more requested AI models.
an Endpoint Ip Address of the Ue.

In some example implementations, the AI Model Transfer Tunnel Request may be a request of one or more PDU sessions for AI model transfer from the AMF and may include at least one of the following:
An endpoint IP address of the UE.
The number of the requested PDU sessions.
One or more PDU session identifiers: to indicate the identifier of requested PDU Session for the transfer of the AI network management models.
A size for each requested AI network management model.
The number of requested AI network management models.
An AMF UE NGAP identifier to indicate a UE specific AMF ID via the NGAP interface.
A RAN UE NGAP identifier to indicate an UE specific RAN ID via the NGAP interface.
One or more QoS requirements related to one or more requested AI model.
STEP 4: The core network node (e.g., AMF) 606 may then transmit to the base station the AI model transfer tunnel response 614 upon receiving the AI model transfer tunnel request 612.

In some example implementations, when the AI model transfer tunnel request 612 is to request of one or more QoS flows as mentioned above, the corresponding AI model transfer tunnel response 614 may include at least one of the following:
The AMF UE NGAP identifier to indicate the UE specific AMF ID via the NGAP interface (assuming that the core network node 606 is an AMF).
The RAN UE NGAP identifier to indicate the UE specific RAN ID via the NGAP interface.
The one or more QoS flow identifiers to indicate a successful allocation of the one or more QoS flows for the requested AI models.
One or more failed QoS flows identifiers to indicate the failed allocation of the QoS flows for the requested AI models.
One or more reason for the failed QoS flow allocation for requested AI model
One or more PDU session identifiers that the present QoS flow belong to.

In some example implantations, when the AI model transfer tunnel request 612 is to request of one or more PDU sessions as mentioned above, the corresponding AI model transfer tunnel response 614 may include at least one of the following:
The AMF UE NGAP identifier to indicate the UE specific AMF ID via the NGAP interface (assuming that the core network node 606 is an AMF).
The RAN UE NGAP identifier to indicate the UE specific RAN ID via the NGAP interface.
The one or more PDU session identifiers to indicate the successful allocation of the one or more PDU session for the requested AI models.
One or more failed PDU Session identifiers to indicate the one or more failed allocation of the PDU Session for the requested AI models.
One or more reason for the failed PDU Session allocation for requested AI model.
STEP 5: The base station may then start the RRC Reconfiguration procedure 610 to allocate air-interface resources for the requested tunnels according to the received AI model transfer tunnel response 614.

In the case that one or more QoS flows are to be allocated with the air-interface resources, in order to use RRC Reconfiguration to map QoS flows to the AI model transfer, at least one of the following configurations may be adapted:
In SDAP configuration, a list of QoS flows may be introduced for solely representing AI model transfer, by for example QFIForModelTransfer-addModlist.
For SDAP configuration, the sdap-HeaderDL/UL may be set to a value indicating that SDAP PDU header is ‘present’ to make the transmitted/received SDAP PDU have a header where the QoS flow ID is included. when the QFI present in the SDAP configuration is configured for AI model transfer.
In SDAP configuration, if no additional QFI list is introduced, a flag may be introduced into QoS flow Configurations to indicate that the QoS flows in the present QFI list in SDAP configuration are used for AI model transfer.

In the case that one or more PDU sessions are to be allocated with the air-interface resources for the transfer of the AI models, in order to use RRC Reconfiguration to map the PDU Sessions to the AI model transfer, at least one of the following configurations may be adapted: for each DRB configured for the one or more PDU sessions, one flag may be present in the corresponding radio bearer configuration to indicate that the DRB is for AI model transfer. Alternatively, one flag may be present in the corresponding SDAP configuration to indicate that the corresponding DRBs are for AI model transfer. Alternatively, one flag may be present in the corresponding PDCP configuration to indicate that the corresponding DRBs are for AI model transfer. Alternatively, one flag may be present in the corresponding RLC configuration to indicate the corresponding DRBs are for AI model transfer.
STEP 6: Once the data tunnel and corresponding air-interface resources are established, the AI model origin network device (either the UE 602 or the base station 604) may then start the AI model transfer to the AI model destination network device (either the base station 604 or the UE 602) via the air interface using the established tunnel for AI model transfer.

### Implementations Based on Using a CN Network Node as a Proxy for the Base Station

In some further example implementations for transferring AI network management models between the UE and the base station, a CN network node functioning as a data network node may be used as a proxy of the base station and function as an end point of the AI model transfer. In such a manner, the configuration for the transfer of the AI network management model may be based on normal communication via PDU sessions between the UE and a data network.

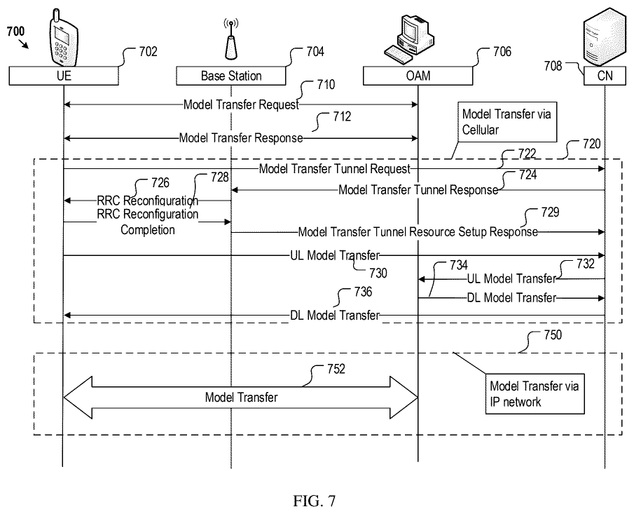

Such an example implementation is shown in the flow diagram 700 in FIG. 7. As shown in FIG. 7, an OAM 706 may be designated as a proxy of the base station 704 and an endpoint of a requested AI model transfer. The other endpoint of the AI model transfer is the UE 702. The OAM 706 may function as a data network node. An AI model transfer request 710 and a corresponding AI model transfer response 712 thus may be communicated between the OAM 706 and the UE 702, with either of them being the requesting network device and the other being the responding network device. The AI model transfer request 710 and the AI model transfer response 712 may be via the base station 704 (as shown by the double direction arrow 710 passing through the base station 704). The AI model transfer request-response procedure are thus between the UE and the OAM.

Following such AI model transfer request-response procedure, two options for the transfer of the AI model may be implemented. In a first option, the transfer may be carried out in the cellular network. For this option, the establishment of one or more PDU sessions in the cellular network for a transfer of the requested AI model and the actual UL or DL transfer of the model may follow the normal cellular data communication between the UE and a data network, as shown by the procedure with the dashed box 720. In a second option, the UE may forego the cellular network, and trigger a transfer of the AI network management model with the OAM as a data network via other communication path or channels, as shown by 750. For example, an IP network such as a Wi-Fi network may exist between the UE and the OAM, and the AI model may be transferred therebetween via the IP communication channel. If needed, a transfer of the AI model may be further performed between the base station and the OAM. For example, for transferring an AI model from the base station to the UE, there may be two implementations: (1) if the AI model is stored at the base station, the base station would transfer the model to the OAM first in order to either use the cellular network option to transfer the AI model from the OAM to the UE via the core network or use the IP network option to transfer the AI model from the OAM to the UE; (2) If the AI model is stored at the OAM but to is be deployed at base station, the base station would transfer some relevant information about the requested AI model transfer to OAM, and OAM either use the cellular network option to transfer the AI model from the OAM to the UE via the core network or use the IP network option to transfer the AI model from the OAM to the UE. For another example, for transferring an AI model from the UE to the base station, there may be two implementations as well: (1) if the AI model is stored at the base station, the OAM would transfer the model to the base station after UE has transferred the model to the OAM either via the first option or the second option above; and (2) if the AI model is stored at the OAM but is to be deployed at based station, the OAM may need to deploy the model to the base station after UE has transferred the model to the OAM either via the first option or the second option above.

In the first option above, the AI model transfer from the UE to the OAM thus is carried out in the user plane (UP) and the AI model is transferred via the core network. In this first option, an AI model transfer tunnel request is made to the core network to establish the PDU sessions. Such a tunnel request may be initiated by the AI model request-response procedure between the UE and the OAM (base station) above. As such, the tunnel request may be considered as being initiated by either the UE or the OAM (base station).

The procedures outlined in FIG. 7 may be implemented as the following steps.
STEP 1: The AI model requesting device (either the OAM 706 or the UE 702) may generate the AI Model Transfer Request 710 and transmitting the request to the responding network device (either the UE 702 or the OAM 706) via the base station 704. The base station 704 is connected with OAM 706 with private interface. For UE initiated request, the AI model transfer request may first be sent form the UE to the base station, and then the base station forward the request to the OAM. For OAM initiated request, the AI model transfer request may first be sent from the OAM to the base station and the base station then forward the request to the UE.

In some example implementations, the AI Model Transfer Request 710 may be implemented as a DL or UL RRC Message (e.g. AI ModelTransferRequest). Alternatively, the AI Model Transfer Request 710 may be implemented as a DL or UL MAC CE (e.g. AI Model Transfer Request MAC CE).

In some example implementations, such AI model transfer request, either via RRC message or MAC CE, either in the UL direction or DL direction, may include at least one of:
An AI based function indication to indicate an AI based function to which the AI model to be transferred belonging to (the AI based function may be one of, e.g., AI based beam management function, AI based CSI enhancement function, AI based positioning enhancement function).
An AI model identification or identifier to indicate the requested AI model. Such identifier may be an AI model ID, or an AI model description that may be used to identify the AI model to be transferred.
An endpoint IP address at OAM side or UE side (depending on which one is the requesting network device).
The network type indication for model transfer: to indicate the network type for the model transfer, such as: NR network, or WLan, or other IP network.
One or more transfer delay requirement (for example, if the AI model transfer is through cellular network, or the first option, there may be network charge or fee for the transfer and the user might want to limit the fee by setting up a time limit).
One or more location requirement (for limiting model transfer to particular locations or location ranges).
One or more transfer quality of service requirement.

In some example implementations, if the AI model transfer request 710 is made by the UE via an UL RRC message to transfer the AI model via the cellular network, such an AI model transfer request may include a NAS message (e.g., a PDU SESSION ESTABLISHMENT REQUEST). One implementation of the NAS message is to request CN to establish a PDU session for the model transfer.

In some example implementations, if the AI model transfer request 710 is made by the UE via an UL RRC message to transfer the AI model via the cellular network, and if AI model transfer request may not include a NAS message (e.g., a PDU SESSION ESTABLISHMENT REQUEST) which is used to request to establish a PDU session for model transfer, it means UE may select an IP network other than the cellular network to perform the model transfer.
STEP 2: The responding network device (either the UE 702 or the OAM 706) transmit to the request network device (either the OAM 706 or the UE 702) the AI Model transfer response message 712 via the base station 704 as a forwarding network device.

In some example implementations, the AI Model Transfer Response 712 may be implemented as a UL or DL RRC Message. In some other alternative implementation, the AI Model Transfer Response 712 may be implemented as a UL or DL MAC CE (e.g. Model Transfer Response MAC CE).

In some example implementations, the AI model transfer response 712, either via RRC message or MAC CE, either in the UL direction or DL direction, may include at least one of:
A Confirmation to the Requested Ai Model.
A failed confirmation to the requested AI model.
The network type indication for model transfer: to indicate the network type for the model transfer, such as: NR network, or WLAN, or other IP networks.
An endpoint IP address at UE side (when UE is the responding network device).

In some example implementations, if the AI model transfer response 712 is made by the UE via an UL RRC message to transfer the AI model via the cellular network, such an AI model transfer response 712 may include a NAS message (e.g., a PDU SESSION ESTABLISHMENT REQUEST) to indicate that the model transfer will be performed via cellular network (e.g. NR wireless network), if model transfer response 712 may not include a NAS message (e.g., a PDU SESSION ESTABLISHMENT REQUEST) to indicate that the model transfer will be formed via the IP network (e.g. WLAN) rather than the cellular network (e.g. NR wireless network). One implementation of the NAS message is to request the CN to establish a PDU session for the model transfer.
STEP 3: If the cellular path 720 has been chosen by the UE, the base station 706 may start a PDU session establishment procedure for the model transfer, and then AI model transfer is performed between UE and gNB/OAM via NR network.

In some example implementation, UE may start the PDU session establishment procedure for the AI model transfer. In some other example implementations, the OAM may start the PDU session establishment procedure for the AI model transfer.

The PDU establishment procedure, for example, may include sending a request 722 for a tunnel by the UE to the core network 708, responding by the core network 708 to the OAM and base station, as shown by 724, the base station 704 sending RRC reconfiguration message 726 to the UE, the RRC reconfiguration procedure, the base station receiving the RRC reconfiguration completion message 728 from the UE, and the base station sending a model transfer tunnel resource setup response message 729 to the more network 708.

The UL AI model transfer via the cellular network, as shown in FIG. 7, may include an UL transfer of the AI model from the UE to the core network via the established PDU session, as shown by 730, and a consequent transfer of the AI model from the core network to the OAM, as shown by 732.

The DL AI model transfer via the cellular network, as shown in FIG. 7, may include a transfer of the AI model from the OAM to the core network, as shown by 732, and a consequent transfer of the AI model from the core network to the UE via the established PDU session, as shown by 736.
STEP 4: If another IP network path has been chosen by UE, it is then up to UE to implementation to transfer AI model via the IP network, as shown by 752 of FIG. 7. In some example implementations, for DL AI model transfer (from gNB to UE), the UE may send an ACK information to the cellular network to inform the cellular network of a completion of the model transfer via the other IP network.

### AI Network Management Model Transfer Between Ue and Core Network As Endpoints

In some example circumstances, AI models trained and/or managed at a UE may need to be transferred to a core network node, and vice versa. Such AI model transfers may be carried at least partially in the air interface and partially in the core network. The various example implementations below provide schemes in which resources for such AI model transfer is configured and in which the model transfer is effectuated. In generally, the transfer of the AI model involving the core network may be implemented in the control plane (CP) of the core network, the user plane (UP) of the core network, or a mix of both planes.

AI Model transfer between the UE and the Core Network based on LTE Positioning Protocol in the Control Plane

In some example implementations, the AI model transfer in the core network may be based on the LTE Positioning Protocol (LPP) in the control plane (CP), both over the air interface and in the core network. The AI model transfer requesting device may be either the core network node involved in the transfer or the UE. Correspondingly, the AI model responding network device may be either the UE or the core network node.

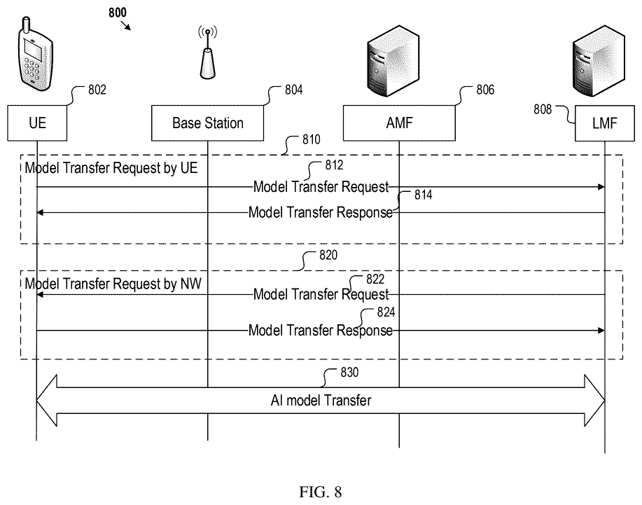

An example implementation is shown in the flow chart 800 of FIG. 8, including an AI model transfer request-response procedure 810 or 820 (depending on whether the UE or the core network is the requester) and the AI model transfer procedure 830.

The LPP based AI model transfer implementation may include the following example steps.
STEP 1: The AI model transfer requesting device (UE 802 or core network node 808) may send an AI Model Transfer Request to the responding device (core network node 808 or the UE 802) using the LPP protocol, as shown by 812 or 822. The core network node 808, for example, may be a Location Management Function (LMF) node. As such, this example implementation is particularly suitable for transferring AI models for positioning and location management.

In some example implementations, the AI Model Transfer Request 812 or 822 may be implemented as a UL or DL LPP Message, and may contain at least one of the following information:
An AI based function indication to indicate an AI based function to which the AI model to be transferred belonging to (the AI based function may be one of, e.g., AI based beam management function, AI based CSI enhancement function, AI based positioning enhancement function).
An AI model identification or identifier to indicate the requested AI model. Such identifier may be an AI model ID, or an AI model description that may be used to uniquely identify the AI model to be transferred, such as model size and other model information.
Service information to indicate the service that requested the AI based function.
A UE identifier to indicate the UE for the LMF to allocate the suitable AI model to the UE (when UE is the requester).
A Physical Cell identifier or Cell Group Identifier (CGI) to indicate the cell to which the UE is connected.
Location information to indicate the current location obtained from legacy information.
STEP 2: The AI model transfer responding device (either the LMF 808 or the UE 802) may send the Model Transfer Response Message to the AI model transfer requesting device (either the UE 802 or the LMF 808) using the LPP protocol, as shown in 814 or 824.

In some example implementations, the AI Model Transfer response 814 or 824 may be implemented as a UL or DL LPP Message, and may contain at least one of the following information:
A confirmation of the requested AI model.
A rejection of the requested AI model.
One of more reasons for the rejection.
STEP 3: After the AI Model Transfer Response Message is received by the requesting device (either the UE 802 or the LMF 808), the UE 802 and the LMF start the AI model transfer using LPP protocol (either UL or DL transfer), as shown by 830.

As further shown in FIG. 8, the communication between the base station and the LMF may be indirect in that such communication go through another intermediate core network node, such as the AMF network node 806 shown in FIG. 8.

In the example implementations above, the LPP Protocol may be used. The transfer of the AI model thus uses SRB resources in the air interface and control plane resources in the core network. For example, the core network interface involved for the transfer of the AI model may be the NG-C interface between the base station and the AMF and the NL1 interface between the AMF and the LMF. In other words, the LPP protocol path used for transferring the AI model may be expressed as LPP=SRB+NG-C+NL1. As such, the transfer of the AI model occurs in the CP of the core network and the air interface in this example implementation.

### AI Model transfer between the UE and the Core Network based on LTE Positioning Protocol in the Control Plane of the Core Network and the User Plane in the Air Interface

In some example implementations, the AI model transfer in the core network may also be based on the LPP, but may occur in a mix of the control plane (CP) and the user plane (UP). Specifically, the AI model may be transferred between the UE and the base station over DRB resources in the air interface in the UP, and then between the base station and the core network as well as in the core network in the CP. The AI model transfer requesting device may be either the UE or the core network node involved in the transfer. Correspondingly, the AI model responding network device may be either the core network node or the UE.

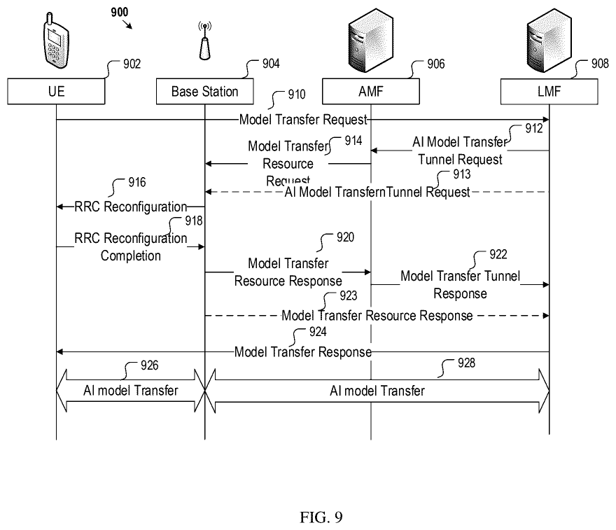

An example implementation is shown in the flow chart 900 of FIG. 9, including (1) an AI model transfer request-response procedure involving the UE sending a AI model transfer request 910 to a core network node, such as the LMF 908 via the base station 904 and the AMF 906, and receiving an AI model transfer response 924 from the LMF 908; (2) a data tunnel and resource establishment procedure involving 912-922 after the AI model transfer request 910 and before the response 924; and (3) the AI model transfer 926 in the air interface over UP resources and the AI model transfer 928 between the base station and the core network and in the core network over CP.

Such implementation based on LPP and with mixed UP and CP transferring FIG. 9 may include the following example steps.
STEP 1: The UE 902 as the AI model requester may generate and send the AI Model Transfer Request 910 to LMF 908 via the base station 904 and the AMF 906 (other types of core network node) using the LPP protocol.

In some example implementations, the AI Model Transfer Request 910 may be transmitted as a UL LPP Message and may contain at least one of the following information:
An AI base function indication to indicate an AI based function to which the AI model to be transferred belonging to (the AI based function may be one of, e.g., AI based beam management function, AI based CSI enhancement function, AI based positioning enhancement function).
An AI model identification or identifier or model information to indicate the requested AI model. Such identifier may be an AI model ID, or an AI model description that may be used to uniquely identify the AI model to be transferred, such as model size and other model information.
Service information to indicate the service that requested the AI based function.
A UE identifier to indicate the UE for the LMF to allocate the suitable AI model to the UE (when UE is the requester).
A Physical Cell identifier or Cell Group Identifier (CGI) to indicate the cell to which the UE is connected.
Location information to indicate the current location obtained from legacy information.
STEP 2: Once the AI model transfer request is confirmed, the LMF 908 may generate an AI Model Transfer Tunnel Request 912 to the AMF 906 via, for example an NL1 interface for acquiring the air-interface resources/tunnels for the requested AI model transfer. Accordingly, the AI Model Transfer Tunnel Request may be an NL1 Message, and may contain at least one of the following information:
AI model information including, for example, a size of each requested AI model, and a number of the requested AI models.
One or more QoS requirements of each requested AI model.
STEP 3: The AMF 906 may the generate and send an AI Model Transfer Resource Request 914 to the base station via, for example an NG-C interface, if the received AI model transfer tunnel request is accepted.

In some example implementations, the AI Model Transfer Resource Request 914 may be constructed to request air-interface resources for one or more QoS flows for the AI model transfer. Such a resource request may contain at least one of the following information:
One or more PDU Session identifiers to identify one or more PDU sessions associated with present QoS flows for the AI model transfer.
One or more QFIs to identify one or more QoS flows for model transfer.
An end point IP address for the AI model transfer.
AI model Information of the requested AI model, such as identifier and size of the AI model.
AI based function information, to indicate the AI based function the requested AI model belong to.
Delay requirement, to indicate the delay requirement of the model transfer
Location requirement, to indicate the location requirement of the model transfer.

In one implementation, the AI Model Transfer Resource Request 914 may be constructed to request air-interface resources for one or more PDU Sessions for the AI model transfer. Such a resource request may contain at least one of the following information:
One or more PDU Session identifiers to indicate one or more PDU session for the AI Model Transfer.
AI model Information of the requested AI model, such as identifier and size of the AI model.
An endpoint IP address for the AI model transfer.
AI based function information, to indicate the AI based function the requested AI model belong to.
QoS requirement associated with the requested AI model, for example: guaranteed bit rate, maximum bit rate, etc.
A list of the QoS flows for each requested AI model associated with the present PDU session.

In another example implementation of step 2 and step 3, once the model transfer request 910 is confirmed, an AI model transfer Resource request may be constructed to request air-interface resources from LMF 908 to the base station directly (a combined 912 and 914). Such a resource request may contain at least one of the following information:
AI model information of the requested AI model, such as identifier and size of the AI model
AI based function information to indicate the AI based function to which the requested AI model belongs.
QoS requirement for each requested AI model, including, for example, guaranteed bit rate, maximum bit rate, etc.
Delay Requirement for Each Requested AI Model.
STEP 4: The base station 904 may then configure the DRB resources for the AI model transfer with the UE 902 via an RRC Reconfiguration message 916, if the AI model transfer resource request is accepted.
STEP 5: The UE 902 may then send an RRC Reconfiguration Completion message 918 to the base station 904 when the RRC Configuration is successfully performed.

In one implementation of the step 4and step 5, if 912 and 914 is present separately, depending on whether QoS flows or PDU sessions are requested, the RRC reconfiguration process of STEP 4 and STEP 5 may follow similar procedure as described above in relation to the procedure of 616, 618, and 620 of FIG. 6.

In another alternative example implementation of the step 4 and step 5, a direct AI model transfer tunnel request 913 from LMF to the base station instead of the separate steps of 912 and 914 may be transmitted. In that case, the RRC reconfiguration process of the step 4 and step 5 may follow similar procedure as described above in relation to the procedure 510 of the DRB based solution.
STEP 6: The base station 904 may send the model transfer resource response 920 to the AMF 906 when the RRC reconfiguration procedure is successfully completed and terminated.

In the case that the AI Model Transfer Resource Request 914 concerns one or more QoS flows as described above, it may include at least one of the following:
An AMF UE NGAP identifier to indicate the UE specific AMF ID via the NGAP interface.
RAN UE NGAP identifier to indicate the UE specific RAN ID via the NGAP interface
The one or more QoS flow identifiers to indicate a successful allocation of the one or more QoS flows for the requested AI models
One or more failed QoS flows identifiers to indicate the failed allocation of the QoS flows for the requested AI models.
One or more reason for the failed QoS flow allocation for requested AI model

In the case that the AI Model Transfer Resource Request 914 concerns one or more PDU sessions as described above, it may include at least one of the following:
The AMF UE NGAP identifier to indicate the UE specific AMF ID via the NGAP interface (assuming that the core network node 606 is an AMF).
The RAN UE NGAP identifier to indicate the UE specific RAN ID via the NGAP interface.
The one or more PDU session identifiers to indicate the successful allocation of the one or more PDU session for the requested AI models.
One or more failed PDU Session identifiers to indicate the one or more failed allocation of the PDU Session for the requested AI models.
One or more reason for the failed PDU Session allocation for requested AI model.
STEP 7: The AMF 906 may generate the AI model transfer tunnel response 922 to the LMF 908 according to the received AI model transfer resource response 920 via, for example the NL1 Interface.

In another alternative example implementation of the STEP 6 and STEP 7, the base station 904 may generate a direct model transfer resource response 923 and transmit it to the AMF 908 directly via, for example, NRL and NG-C interfaces, combining the step 920 and 922 of FIG. 9. Such model transfer resource response 923 may include at least one of the following information:
One or more DRB indication or identifier: To indicate the successful allocation of the one or more DRB resources with which the requested AI model is transferred.
One or more failed DRB identifiers to indicate the one or more failed allocation of the DRB resources for the requested AI model.
One or more reasons for the failed DRB resource allocation for the requested AI model.
STEP 8: The LMF 908 may then generate the AI model transfer response 924 and send it to the UE 902 using the LPP protocol.

In some example implementations, the AI Model Transfer Response 924 may include at least one of the following information:
One or more PDU Session identifiers to indicate the one or more PDU sessions for the AI model transfer.
One or more QoS flow identifiers to indicate the one or more QoS flows for the AI model transfer.
One or more DRB indication or identifiers to indicate the successful allocation of the one or more DRB resources with which the requested AI model is transferred.
AI model Information of the requested AI model, such as identifier and size of the AI model.
AI based function information associated with the requested AI model. Particularly, for AI model transfer between he UE and the LMF, the AI based function may be for positioning management and enhancement.
STEP 9: The LMF 908 and the UE 902 may then start transferring the requested AI model via the LPP Protocol mixed with the user plane (UP) and the control plane (CP). In particular, the transfer 926 between the UE 902 and the base station 904 may be through DRB resources in the UP whereas the transfer 928 between the base station 904 and the AMF 906 and within the core network may be through the CP. The transfer between the base station 904 and the AMF 906 may be via the NG-C interface whereas the transfer between the AMF 906 and the LMF 908 may be via the NL1 interface. Such example mixed LPP approach may be expressed as LPP_Mixed=DRB+NG-C+NL1.

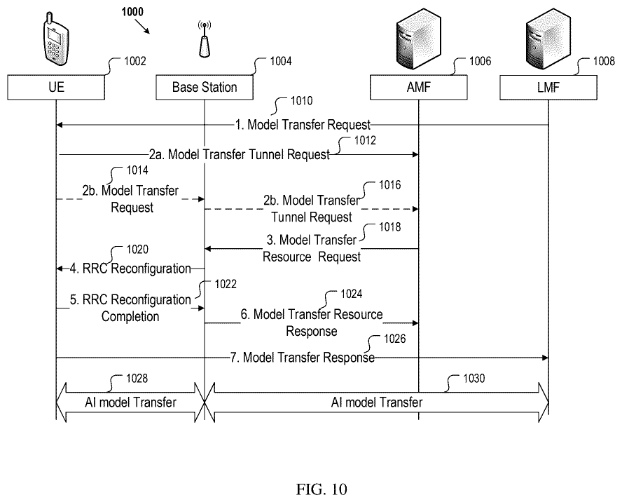

For the LMF being the requesting network device, another example implementation is shown in the flow chart 1000 of FIG. 10, including (1) an AI model transfer request procedure involving the LMF sending a AI model transfer request 1010 to the UE 1002 via the AMF 1006 and the base station 1004, and receiving an AI model transfer response 1026 from the UE 1002 to the LMF 1008 via the base station 1004 and AMF 1006; (2) a data tunnel and resource establishment procedure involving 1012-1024 after the AI model transfer request 1010 and before the response 1026; and (3) the AI model transfer 1028 in the air interface over UP resources and the AI model transfer 1030 between the base station and the core network and in the core network over CP.

Such implementation based on LPP and with mixed UP and CP AI model transfer in FIG. 10 may include the following example steps.
STEP 1: The LMF 1008 may generate the AI Model Transfer Request Message 1010 and may send it to the UE 1002 via the LPP Protocol. The requested AI model, for example may be based on positioning functions relevant to the LMF 1008.

In some example implementations, the AI Model Transfer Request 1010 may be transmitted as a DL LPP Message and may contain at least one of the following information:
An AI based function indication to indicate an AI based function to which the AI model to be transferred belonging to (the AI based function may be one of, e.g., AI based beam management function, AI based CSI enhancement function, AI based positioning enhancement function).
An AI model identification or identifier or model information to indicate the requested AI model. Such identifier may be an AI model ID, or an AI model description that may be used to uniquely identify the AI model to be transferred, such as model size and other model information.
Service information to indicate the service that requested the AI based function.

STEP 2a: The UE 1002 may generate an AI Model Transfer Tunnel Request Message according to the AI model transfer request message 1010 and when the AI model transfer is confirmed, and send it to the AMF 1006 for requesting available tunnel for the AI model transfer.

In some example implementations, the AI Model Transfer Tunnel Request Message may be a N1 Message using NAS signaling such that it is transparent to the base station 1004. The AI model tunnel request message 1012 may request to establish one or more PDU sessions for the AI model transfer. The AI Model Transfer Tunnel Request Message 1012 may contain at least one of the following information:
One or more PDU Session identifiers to indicate one or more PDU session for the AI Model Transfer.
A number of requested QoS flows for each PDU session.
A number of requested AI models.
A size of each requested AI model.
One or more QoS requirements.
A flag to indicate such request message is for AI model transfer.
STEP 2b: Alternative to STEP 2a, the UE 1002 may generate another Model Transfer Request Message 1014 according to the AI model transfer request message 1010 when the AI model transfer is confirmed, and send it to the base station 1004 for requiring available resources for the AI model transfer. The base station 1004 may in turn generate and send a Model Transfer Tunnel Request Message 1016 to the AMF 1006 for requesting the tunnel resources for the AI model transfer according to the received Model Transfer Request Message 1014. The Model Transfer Request Message 1014, for example, may be implemented as a UL RRC Message, and may contain at least of the following information:
The number of requested AI models.
The size of each requested AI model.

In some example implementations, the AI Model Transfer Tunnel Request Message 1016 may be transmitted as an NG-C signaling and may request to modify one or more PDU sessions to add one or more QFI flows for AI model transfer. Such an AI model transfer tunnel request message may contain at least one of the following information:
One or more PDU session identifier for indicating the one or more PDU sessions.
A number of requested QoS flows.
A number of requested AI models.
A size of each requested AI model.
One or More Qos Requirements.
A flag to indicate such that such a request message is for AI model transfer.
STEP 3: The AMF 1006 may generate an AI Model Transfer Resource Request Message 1018 according to the received AI Model Transfer Tunnel Request Message 1012 or 1016, and send it to the base station 1004.
STEP 4: The base station may then start an RRC Reconfiguration procedure 1020 and 1022 to configure the resources according to the received AIA Model Transfer Resource Request Message 1018. Depending on whether QoS flows or PDU sessions are requested, the RRC reconfiguration process of STEP 4 may follow similar procedure as described above in relation to the procedure of 612, 618, and 620 of FIG. 6.
STEP 5: The base station 1004 may then generate an AI Model Transfer Resource Response Message 1024 and send it to AMF after receiving the RRC Reconfiguration Complete Message of 1022.
STEP 6: The UE 1002 may then generate the AI Model Transfer Response Message 1026 and send it to the LMF 1008 when RRC Reconfiguration procedure for establishing resources of model transfer is successfully completed and terminated. In some example implementations, the Model Transfer Response Message 1026 may be transmitted as an LPP Message which may contain at least one of the following information:
A confirmation to the requested AI models.
A rejection to the requested AI models.
One or more reasons of the rejection.
STEP 7: The LMF 1008 and the UE 1002 may then perform the AI model transfer with the LPP-Mixed Protocol of LPP_Mixed=DRB+NG-C+NL1, were the AI model transfer 1028 occurs via DRB in the user plane whereas the AI transfer 1030 occurs in the control plane between the base station and the core network and within the core network.

### General AI Model Transfer Between the UE and the Core Network in the Control Plane

The LPP-based implementations above may be extended to the situation where LMF and LPP is not involved and thus become suitable for also UE/core network transfer of AI models associated with network function rather than positioning. Again, the transfer of the AI models may occur entirely in the control plane of the network including both over the air interface, between the base station and the core network and within the core network.

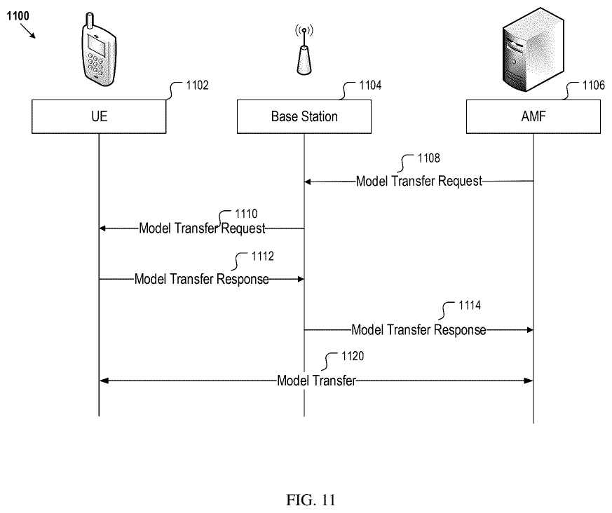

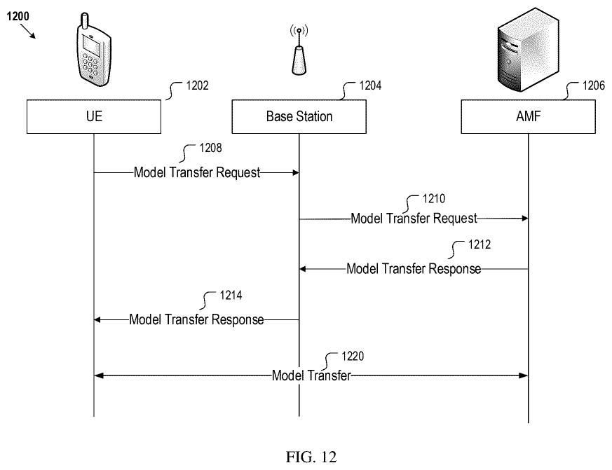

Such a general CP-based model transfer scheme is shown in the flow charts 1100 of FIGS. 11 and 1200 of FIG. 12, for the core network and the UE as the AI model requesting device, respectively. In comparison to the implementation of FIG. 8, the implementations of FIGS. 11 and 12 do not involve the LMF or LPP. In FIG. 11, the core network (e.g., AMF) acts as the requesting device whereas in FIG. 12, the UE acts as the requesting device. They both includes an AI model request-response procedure, and an AI model transfer procedure in the control plane.

As shown in FIG. 11, such an implementation with the core network node (using AMF as an example) being the requesting device, may include the following example steps.
STEP 1: The AMF 1106 generates an AI Model Transfer Request 1108 and send it to the base station via, for example, an NG-C interface. it may contain at least one of the following information:
An AI based function indication to indicate an AI based function to which the AI model to be transferred belonging to (the AI based function may be one of, e.g., AI based beam management function, AI based CSI enhancement function, AI based positioning enhancement function).
An AI model identification or identifier to indicate the requested AI model. Such identifier may be an AI model ID, or an AI model description that may be used to uniquely identify the AI model to be transferred, such as model size and other model information.
An identifier indicating the target UE such as AFM UE NGAP ID or RAN UE NGAP ID.
STEP 2: The base station 1104, in response to receiving the AI model transfer request 1108, may generate and send the AI model transfer request 1110 (e.g., as a DL RRC message) to the target UE 1102 according to the target UE identifier via an SRB resource in the air interface.

In one implementation, the DL RRC message containing the AI model transfer request may include at least one of the following information:
An AI based function indication to indicate an AI based function to which the AI model to be transferred belonging to (the AI based function may be one of, e.g., AI based beam management function, AI based CSI enhancement function, AI based positioning enhancement function).
An AI model identification or identifier to indicate the requested AI model. Such identifier may be an AI model ID, or an AI model description that may be used to uniquely identify the AI model to be transferred, such as model size and other model information.
A transaction ID.

In some example implementations, the base station, when receiving the AI Model Transfer Request 1108 from AMF, may first establish one or more dedicated SRB (as described above) for the AI model transfer, if the SRB has not been previously established before forwarding the AI Model Transfer Request 1110 to UE 1102 via the established SRB resource(s).
STEP 3: The UE 1102 then send an AI Model Transfer Response 1112 to the base station if the requested model transfer is confirmed.

In some example implementations, the AI Model Transfer Response 1112 may be transmitted as a UL RRC Message containing at least one of the following information:
Data of the requested AI model.
Confirmation to each requested AI model.
Rejection to each requested AI model
The reason for the rejection, if any.
The transaction ID.
STEP 4: The base station 1104 may then forward the AI Model Transfer Response 1114 to the AMF 1116.
STEP 5: The UE 1102 and the AMF 1106 may then start the AI model transfer 1120 with the allocated SRB resource(s) and the control interface of NG-C between the base station and AMF. The transfer thus can be expressed as: CP solution=SRB+NG-C.

FIG. 12 further shown the flow chart 1200 for effectuating AI model transfer between the UE and the core network (e.g., AMF) via the control plane, similar to FIG. 11, but with the UE being the requesting device. The implementation of FIG. 12 may include the following example steps.
STEP 1: the UE 1202 may generate an AI Model Transfer Request 1208 and send it to the base station 1204 according to the AI based function via an SRB resource.

In some example implementations, the AI Model Transfer Request 1208 may only be sent via SRB resources dedicated for AI model transfer. If Such SRB resources are not configured, the Model transfer request by UE may not be allowed. In some other example implementations, the AI Model Transfer Request may be sent via legacy SRB resources shared with transmission of other signaling/control information.

In some example implementations, the AI model transfer request message may be transmitted as a UL RRC Message which may contain at least one of the following information:
An AI based function indication to indicate an AI based function to which the AI model to be transferred belonging to (the AI based function may be one of, e.g., AI based beam management function, AI based CSI enhancement function, AI based positioning enhancement function).
An AI model identification or identifier to indicate the requested AI model. Such identifier may be an AI model ID, or an AI model description that may be used to uniquely identify the AI model to be transferred, such as model size and other model information.
A transaction identifier to indicate the AI transfer transaction procedure.
STEP 2: The base station 1204 may then generate or forward the NG-C Message AI Model Transfer Request 1210 for transmission to the AMF 1206. In addition to the information included in the UL RRC message which may further include target UE ID, such as AMF UE NGAP ID or RAN UE NGAP ID.
STEP 3: The AMF 1206 may then generate and send an AI Model Transfer Response 1212 to the base station 1204 if the requested model transfer is confirmed. In one implementation, the AI Model Transfer Response 1212 may be transmitted as an NG-C Message, which may contain at least one of the following information:
Confirmation to each requested AI model.
A rejection to the requested AI model.
One or more reasons of the rejection.
AMF UE NGAP ID.
RAN UE NGAP ID.
The requested resource for AI model transfer.
STEP 4: The base station may then generate or forward the AI Model Transfer Response Message 1214 to the UE via an SRB in the air interface. In some implementations, the base station may first establish one or more dedicated SRB (as described above) for the AI model transfer by including an RRC Reconfiguration message, if the SRB has not been previously established before forwarding the AI Model Transfer response 1214 to UE 1202 via the established SRB resource(s). In some other example implementations, the AI model transfer response message may contain at least one or the following information:
the confirmation to the requested model.
the rejection to the requested model.
The reason of the rejection.
The Transaction ID.
The RRC Reconfiguration for establishing one or more SRB for the AI model transfer.
STEP 5: The UE 1202 and the AMF 1206 may then start the AI model transfer via the allocated SRB resource(s) in the air interface and in the control plane between the base station 1204 and the AMF 1206 via, for example the NG-C interface. The transfer thus can be expressed as: CP solution=SRB+NG-C, similar to the implementation of FIG. 11. In some example implementation, a NAS message within an RRC message may be used for the AI model transfer, meaning that the AI model information may be transparent to the base station.

### AI Model Transfer Between the UE and the Core Network Using Virtual DNN or OAM in the User Plane

For general UP-based AI Model transfer terminated between UE and CN, a virtual DNN (vDNN) or OAM in the CN may be used for the model transfer. In one implementation, a virtual DNN or OAM may be connected with the AMF with private interface. In another implementation, a virtual DNN or OAM may be connected with the UPF with private interface. In such situations, the normal UP data tunnel establishment procedure may be relied on for the allocation and configuration of resources for the transfer of the AI models.

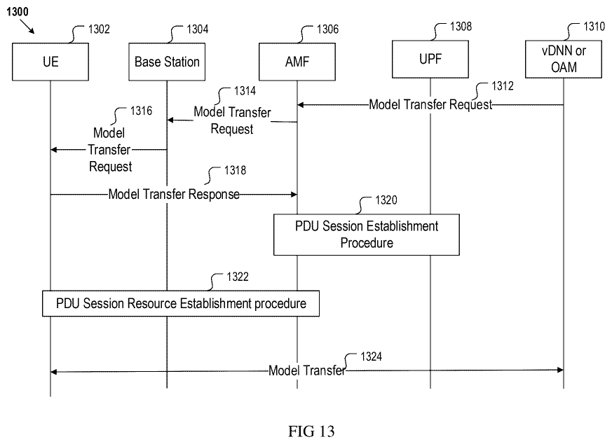

An example is shown in flow chart 1300 of FIG. 13, for AI model transfer requests being made from the network side (e.g., from the vDNN or OAM 1310). Such a solution utilizes PDU sessions for the transfer of the AI models. The transfer thus may be made entirely in the user plane. The example implementation of FIG. 13 may include a model transfer request-response procedure 1312-1318, a PDU session and PDU session resource establishment procedure 1320 and 1322, and the AI model transfer 1324, which may include the following steps.
STEP 1: The AMF may first send an AI model transfer request 1314 to the base station 1304. In some implementations, such request may be obtained by the AMF 1306 from the OAM and/or vDNN 1310 via private interface. In some example implementations, the AI model transfer request 1314 may be transmitted as an NG-C message, and it may contain at least one of the following information:
An AI based function indication to indicate an AI based function to which the AI model to be transferred belonging to (the AI based function may be one of, e.g., AI based beam management function, AI based CSI enhancement function, AI based positioning enhancement function).
Information with respect to each requested AI model including but not limited to a model ID or model description.
The QoS (Quality of service) requirements of each requested AI model, for example, the guaranteed bit rate, the maximum bit rate, etc.
Target UE identifier including but not limited to AMF UE NGAP ID or RAN UE NGAP ID.
An endpoint IP address to indicate that the endpoint of IP address for UL model transfer.
STEP 2: the base station 1304 may then generate an AI model transfer request message 1316 to the UE 1302.

In some example implementations, the AI Model Transfer Request Message 1316 may be transmitted as a DL RRC message and may contain at least one of the following information:
An AI based function indication to indicate an AI based function to which the AI model to be transferred belonging to (the AI based function may be one of, e.g., AI based beam management function, AI based CSI enhancement function, AI based positioning enhancement function).
Information with respect to the requested AI model including but not limited to a model ID or model description.
An endpoint IP address to indicate that the endpoint of IP address for UL model transfer
Transaction ID.
STEP 3: The UE 1302 generate an AI Model Transfer Response Message 1318 to the AMF 1306 if the model transfer request is confirmed.

In some example implementations, the AI Model Transfer Response Message 1318 may be transmitted as a UL RRC Message and may include a NAS message (i.e. PDU SESSION ESTABLISHMENT REQUEST) which is sent to AMF 1306 to trigger a PDU Session Establishment procedure for AI model transfer.

In some example implementations, the Model Transfer Response Message may contain the at least one of the following information:
A confirmation to the requested AI models.
A rejection to the requested AI models, if any.
One or more reasons of the rejections.
The endpoint IP address: To indicate that the endpoint of IP address for the model transfer.
STEP 4: The AMF 1306 may then start a PDU Session establishment procedure 1320 within the core network according to the response message 1318 from UE 1302.
STEP 5: After the AMF 1306 starting the PDU session establishment procedure, the UE 1302, the base station 1304 and the AMF 1306 may start the PDU session resources setup procedure 1322 in order to configure the DRB resources for the PDU session.
STEP 6: After the PDU session resources request procedure 1322 is successfully terminated for which at least one DRB resource is established for the PDU session, the UE 1302 and vDNN/OAM 1310 may then start the model transfer 1324 via UPF 1308 using the established PDU session.

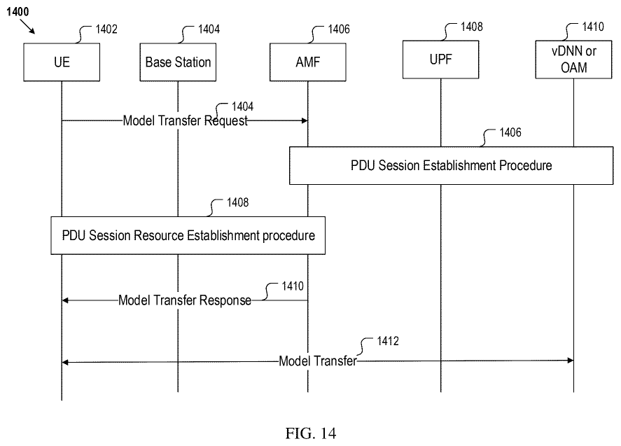

Another example is shown in flow chart 1400 of FIG. 14, for AI model transfer requests being made from the UE side. Such a solution also utilizes PDU sessions for the transfer of the AI models. The transfer thus may be made entirely in the user plane. The example implementation of FIG. 14 may include a model transfer request-response procedure 1404 and 1410, a PDU session and PDU session resource establishment procedure 1406 and 1408, and a AI model transfer 1324, which may include the following steps.
STEP 1: The UE 1402 may first send an AI Model Transfer Request via the base station 1404 to the AMF 1406. In some example implementation, the AI Model Transfer Request 1404, and may contain at least one of the following information:
a Message (e.g., a Pdu Session Establishment Request) to Request the AMF to establish a PDU session for the AI model transfer.
An AI based function indication to indicate an AI based function to which the AI model to be transferred belonging to (the AI based function may be one of, e.g., AI based beam management function, AI based CSI enhancement function, AI based positioning enhancement function).
Information with respect to the requested AI model including but not limited to a model ID or model description.
The QoS requirements of each requested AI model, for example, the guaranteed bit rate, the maximum bit rate, etc.

STEP 2: If the request from UE 1402 can be confirmed by AMF 1406, the AMF may start the PDU Session Establishment Procedure 1406 in the core network according to a received PDU SESSION ESTABLISHMENT REQUEST.
STEP 3: The AMF 1406, the base station 1404 and the UE 1402 may then start a PDU session resource setup procedure 1408 to establish the DRBs in the air interface for the requested AI model transfer.
STEP 4: The AMF 1406 may generate an AI Model Transfer Response Message 1410 to the UE 1402, if the DRB resources are successfully established.

In some example implementations, the AI Model Transfer Response Message 1410 may be an N1 Message and may contain at least one of the following information:
A confirmation to the requested AI model.
A failed confirmation to the requested AI model,
One or more reasons of the rejection.
STEP 5: The UE 1402 and the vDNN or OAM 1410 may then start the AI model transfer 1412 via UPF, i.e., over the established DRB resources in the air interface and in the UP between the base station 1404 and core network and in the core network.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method by a first device to communicate with a second device in a wireless communication system, the first device and the second device being respectively one and another of a wireless terminal and a core network (CN) node, the wireless terminal and the core network node being communicatively connected via a wireless base station, and the method comprising:
performing a request-response procedure with the second device for initiating a transfer of an Artificial Intelligence (AI) network management model therebetween;
identifying a radio bearer resource in an air interface between the wireless terminal and the wireless base station for the transfer of the AI network management model; and
performing the transfer of the AI network management model over the radio bearer resource and a control plane of the wireless communication system.

2. The method of claim 1, wherein the CN node comprises a Location Management Function (LMF) node.

3. The method of claim 2, wherein the AI network management model comprises a location management AI model.

4. The method of claim 2, wherein the transfer of the AI network management model is performed according to an LTE Positioning Protocol (LPP).

5. The method of claim 4, wherein,
the radio bearer resource comprises a Signaling Radio Bearer (SRB) resource and the transfer of the AI network management model is performed over the SRB resource and at least one control interface between the wireless base station and the LMF node; or
the radio bearer resource comprises a Data Radio Bearer (DRB) resource and the transfer of the AI network management model is performed over the DRB resource between the first device and the wireless base station and additionally over at least one control interface in the control plane between the wireless base station and second device.

6. (canceled)

7. The method of claim 4, wherein the wireless terminal and the LMF node is communicatively connected via the wireless base station and an intermediate Access Management Function (AMF) node.

8. The method of claim 7, wherein request-response procedure comprises transmitting an LPP request message comprising at least one of:
a first identifier for identifying an AI based function to which the AI network management model belong;
an attribute of the AI network management model;
a second identifier for indicating a service associated with the AI network management model;
a third identifier for identifying the wireless terminal with respect to the LMF;
a fourth identifier for indicating a cell to which the wireless terminal is connected; or
a location information.

9. The method of claim 7, wherein the request-response procedure triggers a data tunnel request from the LMF to the AMF for the transfer of the AI network management model, the data tunnel request comprising at least one of:
at least one attribute of the AI network management model; or
a QoS requirement associated with the transfer of the AI network management model.

10. The method of claim 9, wherein the data tunnel request triggers the AMF to transmit an AI model transfer resource request to the wireless base station requesting data radio bearer resources for one or more QoS flows or one or more PDU sessions, the AI model transfer resource request comprising at least one of:
PDU Session identifiers for identifying the one or more PDU sessions whose QoS flows need to be modified, or which need the wireless base station to establish air-interface resources;
QoS flow identifiers for identifying the one or more QoS flows which need to be added or modified for the model transfer or which need to be included the identified PDU sessions;
an endpoint IP address of the model transfer;
the at least one attribute of the AI network management model; or
the QoS requirement associated with the transfer of the AI network management model.

11. The method of claim 10, wherein the AI model transfer resource request triggers the wireless base station to initiate an RRC reconfiguration for mapping the one or more QoS flows or one or more PDU sessions to the radio bearer resource for the transfer of the AI network management model via at least one of:
a list of AI model transfer specific QoS flows present in an SDAP configuration;
a configuration indicating a presence of an SDAP PDU header;
a first flag that enables mapping a present QFI list in the SDAP configuration to the transfer of the AI network management model;
a second flag in a DRB configuration indicating that a corresponding DRB is for AI network management model transfer;
a third flag in an SDAP configuration indicating that a corresponding DRB is for AI network management model transfer;
a fourth flag in a PDCP configuration indicating that a corresponding DRB is for AI network management model transfer; or
a fifth flag in an RLC configuration indicating that a corresponding DRB is for AI network management model transfer.

12. The method of claim 11, wherein a response to the AI model transfer resource request from the wireless base station to the AMF comprise at least one of:
a first identifier for indicating a mobile terminal specific Access Management Function (AMF) ID with respect to a NG Application Protocol (NGAP) interface;
a second identifier to indicate a mobile terminal specific Radio Access network (RAN) ID with respect to the NGAP interface;
the QoS flow identifiers for identifying the one or more QoS flows which are confirmed as successfully modified or as successfully added;
the PDU session identifiers for identifying the one or more PDU sessions confirmed as successfully set up or modified;
a third identifier for indicating a failed PDU session allocation or a failed QoS flow allocation for the transfer of the AI network management model; or
at least one reason for the failed PDU session allocation or the failed QoS flow allocation.

13. The method of claim 11, wherein the CN node comprises an Access Management Function (AMF) node.

14. The method of claim 13, wherein the request-response procedure comprises an NAS request for AI model transfer that is transparent to the wireless base station, the NAS request comprising at least one of:
a first identifier for identifying an AI based function to which the AI network management model belong;
an attribute of the AI network management model;
a second identifier for identifying the wireless terminal; or
a transaction identifier for identifying the transfer of the AI network management model.

15. The method of claim 14, wherein request-response procedure comprises the wireless base station establishing an SRB resource dedicated to a purpose of AI network management model transfer.

16. A method by a first device to communicate with a second device in a wireless communication system, the first device and the second device being respectively one and another of a wireless terminal and a network node, the wireless terminal and the network node being communicatively connected via a wireless base station, the network node being either a virtual Data Network Node (vDNN) or an Operation/Administration/Maintenance (OAM) node of the wireless communication system, and the method comprising:
performing a request-response procedure with the second device for initiating a transfer of an AI network management model between the first device and the second device;
identifying one or more PDU sessions between the first device and the second device; and
performing the transfer of the AI network management model between the first device and the second device using the one or more PDU sessions.

17. The method of claim 16, wherein the request-response procedure comprises transmitting or receiving a first NAS message contained in a first RRC message as a request, the first NAS message comprising at least one of:
a first identifier for identifying an AI based function to which the AI network management model belong;
an attribute of the AI network management model; or
an endpoint IP address of the wireless terminal.

18. The method of claim 17, wherein the request-response procedure further comprises transmitting or receiving a second NAS message contained in a second RRC message, the second NAS message being configured to trigger a PDU session establishment procedure for the transfer of the AI network management model.

19. The method of claim 18, wherein the second NAS message comprises at least one of:
a confirmation for receiving the request;
a rejection of the request; or
at least one reason for the rejection.

20. The first device, comprising a memory for storing instructions and a processor for executing the instructions to implement claim 1.

21. A computer readable non-transitory medium for storing computer instructions, the computer instructions, when executed by a processor of the first device of claims 1-19, are configured to cause the first device to implement claim 1.
